(19) United States
(12) Patent Application Publication
(10) Pub. No.: US 2007/0143127 A1
(43) Pub. Date: Jun. 21, 2007

(54) Virtual host

(76) Inventors: Matthew Laurence Dodd, Enner Glen (NZ); Matthew James Rush, Richmond (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/313,314

(22) Filed: Dec. 21, 2005

(51) Int. Cl. G06Q 99/00

(52) U.S. Cl. 705/1

(57) ABSTRACT

The present invention relates to a self-service engine for implementation in a business management system for rendering a virtual host. The virtual host replaces a customer service representative usually employed in an enterprise, such as a retail outlet, hotel or the like, who assists a customer. The self-service engine determines responses to events based on a set of rules, and renders the response on output devices. The response might, for example, be rendered as an animated human with a voice output.

### FIELD OF THE INVENTION

The present invention relates to a system, whereby a self-service engine utilises a virtual host to facilitate interactions between a customer and an enterprise providing goods and/or services.

### BACKGROUND TO THE INVENTION

Traditionally, enterprises that provide goods and/or services to customers utilise customer service representatives to facilitate the transactions or interactions taking place. For example, in retail outlets, restaurants, bars, information centres and the like, the customer service representative, such as a shop assistant, bartender or the like, employed by the enterprise provides a customer with information, assistance, and goods/services, and obtains payment for the goods/services from the customer.

Due to changing business models, enterprises have begun looking at alternatives to on-site customer representatives to facilitate these transactions. For example, many businesses have moved to using mail order, internet transactions and/or call centres. The drawback of such approaches is that the customer experience is diminished due to the lack of “face-to-face” contact.

There is a need to provide an alternative means for facilitating transactions or interactions with the customer, that provides a more “real-life” experience.

### SUMMARY OF THE INVENTION

It is an object of the present invention to provide a system that facilitates communication and transactions between a customer and an enterprise. The system might comprise, for example, a self-service engine that renders a non-human computer controlled host that communicates with the customer, via various means such as animations, sound, text and other multimedia inputs and outputs. The human-like computer controlled host is termed a “virtual host”

In one aspect, the present invention may be said to consist in A computer program for use in a self-service engine that generates responses to events relating to customer activity, the program being adapted to: receive input indicating a detected event in relation to an activity, generate a candidate set of possible responses by using a set of rules, wherein each rule associates one or more possible events with one or more possible responses, select one response from the candidate set of possible responses, and generate the selected response for rendering on one or more output devices.

Preferably when the computer program generates a candidate set of possible responses, the set of rules is used to identify those responses that are appropriate for the detected event by generating a priority for each response, wherein the one or more responses with the highest priority are included in the candidate set of possible responses.

Preferably, the set of rules further generates a weighting for each identified response, and wherein one response is selected from the candidate set of possible responses using a random process with each possible response being biased according to the weighting.

Preferably the computer program is further adapted to model an emotional state and modify the priority and/or weighting of each response.

Preferably the selected response is rendered to dynamically include variable content from external sources.

Preferably, the self-service engine is implemented in a business management system of one of: a retail outlet, a restaurant, a bar, an accommodation provider, video rental store, a gaming outlet, a car rental outlet, a travel outlet, and an information kiosk.

Preferably the event is one or more of: a communication by the customer, an action by the customer, and a previous response by the self-service engine.

Preferably a response is one or more of: dialogue, an assertion, an instruction, provision of information, modification of a menu, operation of a device, and operation of a transaction system.

Preferably the generated response is rendered as one or more of: an animation, a voice text output, a printout, operation of a device, and an image.

In another aspect the present invention may be said to consist in a business management system implementing a self-service engine for facilitating transactions with a customer comprising: one or more input devices for detecting an event associated with a customer transaction, a transaction system for effecting a transaction instigated by a customer, a transaction system interface for transferring information relating to the transaction to the transaction system, a response generator coupled to one or more of the input devices, for generating a response to a detected event, the response generator comprising: a datastore containing a set of rules, wherein each rule associates one or more possible events with one or more possible responses, and a processor for determining a candidate set of possible responses to a detected event based on the set of rules, and for selecting one response from the candidate set of possible responses, and one or more output devices coupled to the response generator for rendering the selected response to the customer.

Preferably when the business management system determines the candidate set of possible responses, the processor uses the set of rules to identify those responses that are appropriate for the detected event by generating a priority for each identified response, wherein the one or more responses with the highest priority are included in the candidate set of possible responses.

Preferably the processor further generates a weighting for each identified response, and wherein the processor selects one response from the candidate set of possible responses using a random process with each possible response being biased according to its respective weighting.

Preferably the processor is further adapted to model an emotional state and modify the priority and/or weighting of each response.

Preferably the event includes one or more of: a communication by the customer, an action by the customer, and a previous response by the business management system.

Preferably the business management system is implemented in one of: a retail outlet, a restaurant, a bar, an accommodation provider, video rental store, a gaming outlet, a car rental outlet, a travel outlet, and an information kiosk.

Preferably the transaction system is one or more of: a reservation system, a point of sale system, a customer loyalty database, a marketing database, an internet host database an inventory control system, and an information database for a information kiosk.

Preferably a response is one or more of: dialogue, an assertion, an instruction, provision of information, modification of a menu, operation of a device, and operation of a transaction system.

Preferably the selected response is rendered as one or more of: an animation, a voice text output, a printout, operation of a device, and an image.

Preferably the one or more output devices are one or more of: a visual display, and an audio speaker.

Preferably the one or more input devices are one or more of: a touch screen, a microphone, a motion sensor, a camera, a payment card reader, a barcode scanner, printer, and text service provider.

In another aspect the present invention may be said to consist a self-service engine for facilitating interactions between a customer and a transaction system of an enterprise comprising: one or more input devices for detecting an event associated with a customer interaction, a transaction system interface for transferring information relating to the interaction to and from a transaction system of an enterprise, a response generator coupled to one or more of the input devices, for generating a response to a detected event, the response generator comprising: a datastore containing a set of rules, wherein each rule associates one or more possible events with one or more possible responses, and a processor for determining a candidate set of possible responses to a detected event based on the set of rules, and for selecting one response from the candidate set of responses, and one or more output devices coupled to the response generator for conveying the selected response to the customer.

Preferably when the self-service engine determines the candidate set of possible responses, the processor uses the set of rules to identify those responses that are appropriate for the detected event by generating a priority for each identified response, wherein the one or more responses with the highest priority are included in the candidate set of possible responses.

Preferably the processor further generates a weighting for each identified response, and wherein the processor selects one response from the candidate set of possible responses using a random process with each possible response being biased according to its respective weighting.

Preferably the processor is further adapted to model an emotional state and modify the priority and/or weighting of each response.

Preferably an event includes one or more of: a communication by the customer, an action by the customer, and a previous response by the business management system.

Preferably, the self-service engine is implemented in one of: a retail outlet, a restaurant, a bar, an accommodation provider, video rental store, a gaming outlet, a car rental outlet, a travel outlet, and an information kiosk.

Preferably the transaction system is one or more of: a reservation system, a point of sale system, a customer loyalty database, a marketing database, an internet host database, an inventory control system, and an information database for a information kiosk.

Preferably a response is one or more of: dialogue, an assertion, an instruction, provision of information, modification of a menu, operation of a device, and operation of a transaction system.

Preferably the selected response is rendered as one or more of: a human-like animation, a non-human animation, a voice text output, a printout, operation of a device, and an image.

Preferably the one or more output devices are one or more of: a visual display, and an audio speaker.

Preferably the one or more input devices are one or more of: a touch screen, a microphone, a motion sensor, a camera, a payment card reader, a barcode scanner, printer, and text service provider.

In another aspect the present invention may be said to consist in a response generator, for use in a self-service engine, that generates responses to events relating to customer activity: an input interface for coupling to one or more input devices adapted to detect an event associated with a customer transaction, a datastore containing a set of rules that associate one or more events with one or more responses, a processor that can access the datastore and input interface for determining a candidate set of possible responses to a detected event based on the set of rules, and for selecting one response from the candidate set of responses, and an output interface for providing the selected response to one or more output devices adapted to render the selected response for the customer.

### BRIEF DESCRIPTION OF THE DRAWINGS

Preferred embodiments of the invention will be described with reference to the drawings, of which:

FIG. 1 is a block diagram of a business management system according to the present invention, including a self-service engine,

FIG. 2 is a block diagram indicating the main components of the self-service engine which forms part of the business management system,

FIG. 3 shows the main application and system of the self-service engine in further detail,

FIG. 4 shows a block diagram of the dialogue management system in further detail,

FIG. 5 shows a screen shot of an example human-like animated virtual host,

FIG. 6 shows a flow diagram of operation of the self-service engine,

FIGS. 7A and 7B are partial views of a flow diagram of the response determination process in further detail,

FIG. 8 shows a purchases window,

FIG. 9 shows an edit/add item dialog window,

FIG. 10 shows a products window, and

FIG. 11 shows an editor window.

### DETAILED DESCRIPTION OF PREFERRED EMBODIMENTS

Description of System

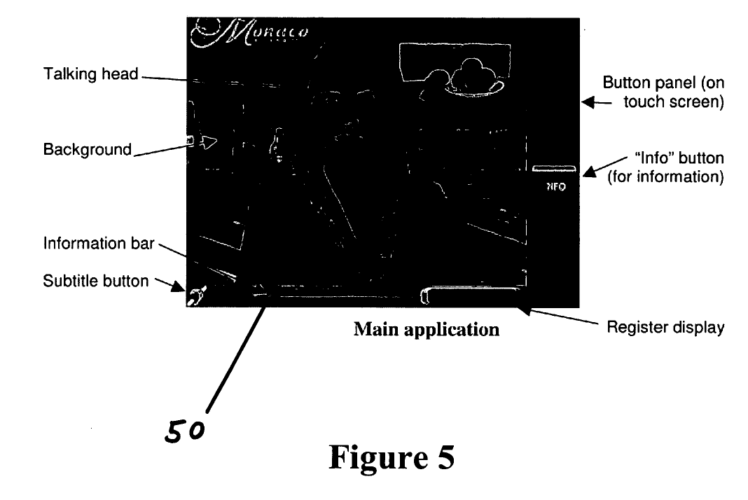

FIG. 1 shows a block diagram giving a general overview of a business management system 1 which utilises a virtual host. A business management system comprises a self-service engine 11 which is integrated with the existing transaction 12 and database systems of the enterprise. The transactions systems, could include, for example, a point of sale system 12d, inventory system 12b, marketing system 12c, internet 12d, accounting system, booking/reservation system (not shown) and any other existing systems operated by the enterprise to carry out transactions or store data in relation to the goods and/or services that they provide. The term “transaction systems” does not relate solely to systems that facilitate purchasing, but any system operated by the enterprise which enables the day-to-day running of the business to enable provision of their goods and/or services to customers. Alternatively, the business management system 1 could include dedicated transaction systems 12 designed specifically for use with the self-service engine 11. The self-service engine 11 renders a virtual host 50 (see FIG. 5), which provides a means by which a customer can obtain the goods and/or services that they desire from the enterprise and carry out the usual transaction activities they would normally undergo with a human customer service representative. For example, the virtual host 50 might comprise a human animation and audio output that together mimic the dialogue and actions of a real host. The combination of the self-service engine 11 (which among other things renders a virtual host) and the existing transaction systems 12 provides an overall business management system 1 that provides a virtual host interaction experience for the customer, enabling the customer to access and purchase the goods and services of the enterprise running the business management system, without the need for a customer service representative.

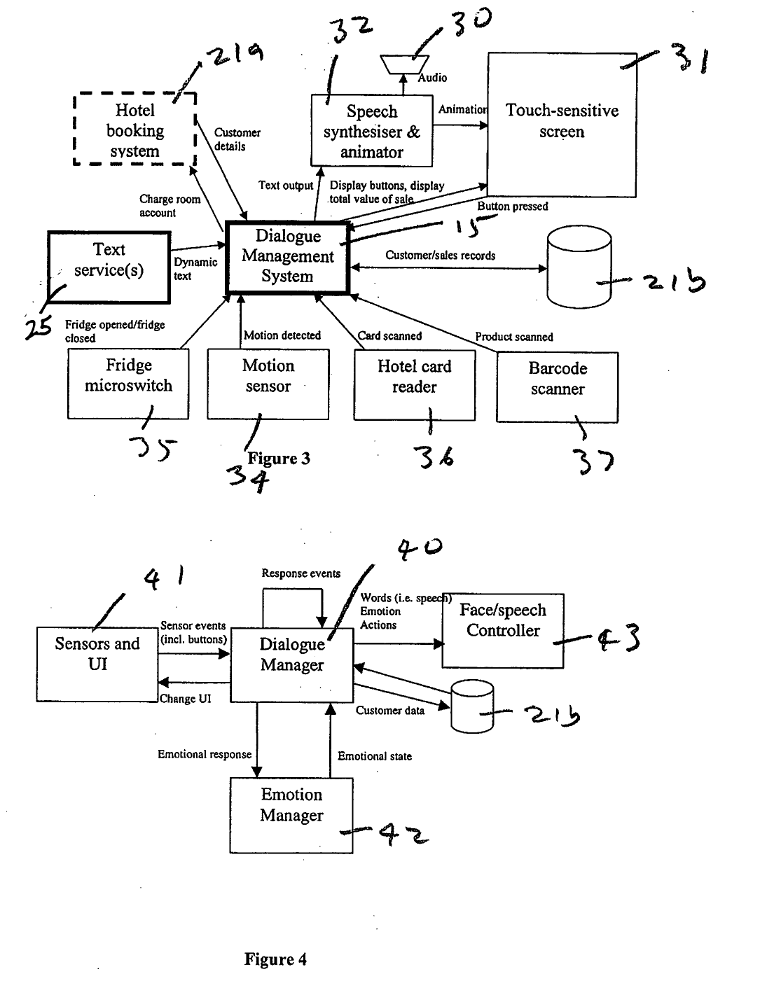

In summary, the self service engine 11 comprises a presentation layer 14, dialogue management system (DMS) 15, and middleware layer 16. The presentation layer provides the user interface between the customer and the overall business management system 1 generally including a display which renders a human animation 50, audio outputs which provide voice, other visual outputs, and a range of input means for customer interaction. The DMS 15 primarily generates the responses that are conveyed to the customer via the presentation layer 14, in response to events. These responses can include changes to the information and/or menus displayed onscreen as well as spoken responses by the animated virtual host. The middleware layer 16 provides the interface that allows the self-service engine 11 to integrate with the existing or specifically designed transaction system 12 of the enterprise. The self-service engine 11 also includes a range of input devices and equipment (shown in FIG. 3) which enables the self-service engine to provide and facilitate transactions and provide the goods and/or services of the enterprise to the customer as required. The term transaction can be used broadly to mean the entire process or any part of the process between the customer first entering the premises and indicating that some type of good or service is required up until the point that payment is made and the customer leaves the premises with the purchased goods and/or services. The transaction is effectively the interactions the between the customer and virtual host.

A business management system 1 could be implemented in a range of enterprises. For example, it could be implemented in retail outlets, restaurants/bars, supermarkets, information kiosks, utility provider outlets, government offices, video stores and the like. It will be appreciated that this list is not exhaustive and one skilled in the art could apply the invention to a range of other enterprises. It could be used in any situation where a human customer service representative is normally present. The remainder of the description will relate to the implementation of a business management system 1 in relation to a hotel bar which provides drinks and food to a customer. However, it will be appreciated that the example is provided for illustrative purposes only and the invention is not limited solely to this implementation. A self-service engine 11 could be integrated in a range of systems 1 run by other enterprises.

The virtual host 50 driven by the self service engine 11 provides an experience that engages the customer, much in the way a human customer service representative would. For example, the facial animations and movements, spoken outputs and other responses are personalised based on the emotional state of the dialogue, the interactions of the customer, and the profile of the customer based on built up information, such as favourite purchases and previous visits.

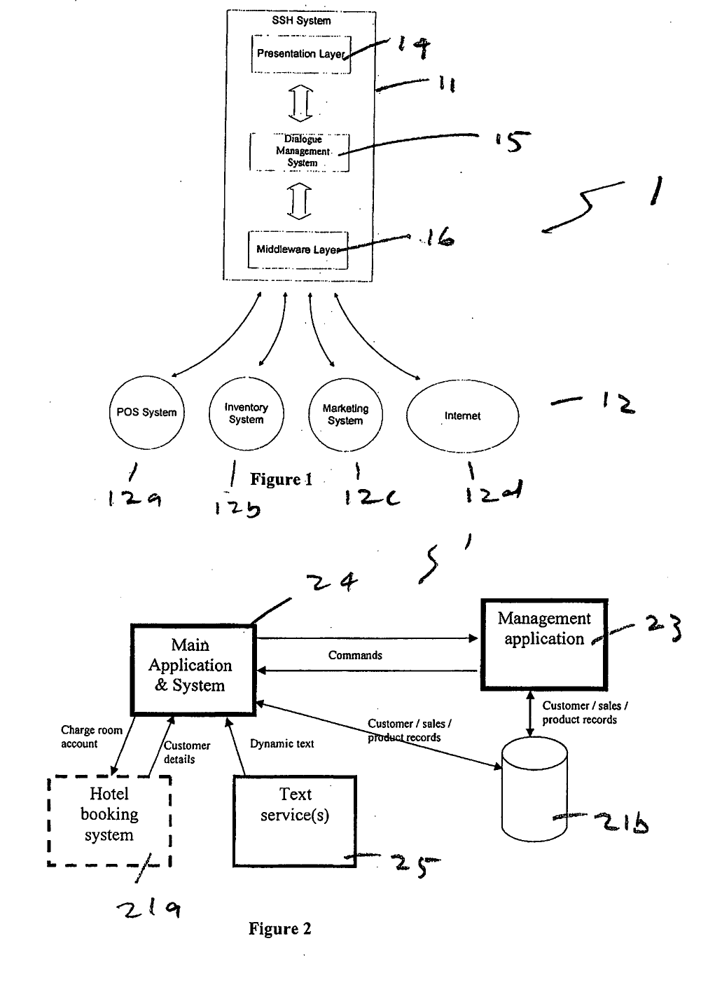

FIG. 2 shows a block diagram of an overview of a preferred embodiment of the invention applied in the context of the hotel bar. The system 1 includes a self-service engine 11 connected to the existing booking system 21a and customer record database of the hotel 21b. These form part of the transaction system 12. In FIG. 2, the existing systems may further include an electronic point of sale transaction system, inventory system, accounting system and the like all of which can be accessed and manipulated as required by the self-service engine. It will be appreciated that the system may be implemented with new transaction systems specially designed for the business management system, rather than using existing transaction systems.

The self-service engine 11 includes a main application connected to additional user input devices and appliances which form the overall main system 24. It also includes a management application 23 and a text service 25. In summary, the system 1 allows a customer entering the hotel bar to order a drink or food via the self-service engine, and collect and pay for the purchase, either by putting it on their hotel room account or paying by an electronic method. During the transaction, a virtual host 50 will interact with the client, and guide them through the transaction process. The virtual host 50 is preferably one or more of a human animation, voice, text output and/or other communications means.

FIG. 3 shows the self-service engine 11 in further detail. The core of the self-service engine 11 is the dialogue management system (DMS) 15. This DMS monitors all the events occurring during the transaction and generates appropriate responses for conveying to the customer during particular points in the transaction process. In general terms, the DMS 15 provides a framework for executing a dialogue path during a particular interaction between the user and the application. It is envisaged that the DMS 15 be implemented as a central component in an application that is intended to interact with the user in a “human-like” manner. The DMS 15 would provide the application with the methods for receiving arbitrary input events (e.g. when the user presses a button) and performing “human-like” responses that would be variable and unpredictable.

The DMS 15 has: (a) an interface unit that accepts events from the user of the system; (b) a collection of events (including response events) that have been received during the course of the dialogue; (c) a set of responses that may be selected and performed at any moment and which may contain content to be displayed or provided to the user, or which may perform response-specific actions (d) a set of rules, relating to the responses, that determine whether, at any given moment, each response may be selected; (e) a unit that maintains an emotional state for the dialogue, (f) a unit that applies the rules according to the collection of events and the motional state of the dialogue; and (g) an interface unit to allow the responses to be communicated to the user. The DMS 15 is configured for any particular interactive application with the responses and rules that are relevant to producing the proper dialogue paths for that application. A non-limiting, but preferred method for configuring the DMS 15 is via an XML configuration file, where the responses are specified by XML elements containing attributes and sub-elements that specify the rules and content for the response.

During the operation of the DMS 15, responses are selected and performed moment-to-moment based on the current state of the dialogue. Specifically, a response may be randomly and spontaneously performed at any moment without being directly preceded by a particular input event. Such a response would typically be dependent on the current state of the dialogue (so as to be in context), but would not be in direct response to a particular input event, thus providing variability and unpredictability. By performing a particular response, the future path of the dialogue is impacted. The dialogue (or “state of the dialogue”) is the particular collection and sequence of events that have occurred thus far during the interaction between the DMS 15 and the user. The dialogue path is the sequence of responses that have been performed by the DMS 15 during a particular dialogue. Subsequent dialogues will most likely follow a different path to any previous dialogue due to the dialogue experiencing different input events and due to the DMS 15 selecting different responses when selecting from conflict sets. Where a different path is followed, the user will experience a unique interaction. A given response may make other responses more or less likely to occur in the future, and, in some cases, may make other responses necessary (typically immediately following the current response), or impossible.

Note that a response may take some time to perform (such as a sentence being spoken by a text-to-speech system). In such a case, the DMS 15 can indicate in each response whether or not that response can be “interrupted” during its performance by certain subsequent responses. Where a new response interrupts an earlier response during its performance, that earlier response will be stopped and the new response will begin performing immediately. Conversely, where a new response does not interrupt an earlier response, that earlier response will be allowed to complete before the new response begins being performed.

A conflict set (to be explained in further detail later) is created during response selection, consisting of all the responses that can be performed at the present moment in time. Where multiple responses are in that conflict set (A), the DMS 15 will randomly select a single response (R) to perform. Subsequently, responses that had been in conflict set (A) may not be in the next conflict set (B), and, conversely, responses that were not in conflict set (A) may subsequently be in conflict set (B), due to the change in the state of the dialogue caused by the response (R).

This mechanism of selecting from a conflict set also provides for variations of the dialogue path and content between interactions, thus allowing the user to experience variable interactions on subsequent visits. The conflict set may include different types of responses, and it may include the same types of response that vary only in content. Note that if only the content is varied, the dialogue path is not varied, whereas if the dialogue path is varied (by varying the type of response given), the content is varied by necessity.

For example, a variation in only the content of a response of the type “SayHello” might be (a) “Hello”, and (b) “Hi”. In this case, the two alternatives may be considered identical with respect to the dialogue path, so long as all other aspects of the response are equal.

A variation of the dialogue path, however, would occur where the type of response is different, such as “SayHello” versus “TalkAboutTheWeather”, or where the response causes, for example, a change in the emotional state. Each different response would cause the dialogue path to diverge.

Normally, a response would include any content that is to be displayed or provided to the user in the application (although it can be left to the application to determine the content to provide for a given type of response). The content of the response can come from one of a number of sources, including, but not limited to:

Files;

Databases; and

Network services

Where the content is an XML document, the DMS can (optionally) translate that content using XSLT (Extensible Stylesheet Language Transformations) into a format that is suitable for the application (using an application-specific XSLT file).

A particular response may be performed by several different sub-systems within the application. An individual logical response, which includes content targeting several separate sub-systems, would be performed in this case. Non-limiting examples of such sub-systems would include (a) a text-to-speech system for providing spoken content, (b) an action by an on-screen character, and (c) a screen displaying textual information.

Referring back to FIG. 3, the DMS 15 is interconnected with the existing enterprise transaction systems 12 such as the hotel booking system 21a and customer records database 21b, so that these can be accessed, updated and utilised as required to carry out the transaction and in particular effect payment and other necessary activities of the transaction. The DMS 15 is connected to various output devices through which it can provide responses to the customer, thus facilitating communication. The output devices include a printer, a speaker for outputting voice 30, and a display screen for displaying a human animation and other text, and visual information 31. FIG. 5 shows an example of a human animated virtual host 50 that could be displayed on the screen 31. The DMS 15 is connected to the speaker 30 and display 31 via a speech synthesiser and facial animation software 32 which generates the responses as speech, animations, text, visuals and/or as any other suitable multimedia output. The DMS 15 is also connected to a range of input devices for detecting events, such as activities and/or communications and other inputs from the customer. The input devices can include a touch sensitive portion on the screen 31 for receiving inputs (seen in FIG. 5), a motion sensor for detecting the arrival of the customer 34, a microswitch on the refrigerator doors storing the beverages which can be activated to allow the customer to access the refrigerator 35, a latching mechanism to allow access to the fridge, a customer card reader 36 and a barcode scanner 37. A range of other input devices could also be utilised where required, such as an image recognition system, a voice recognition system and any other user interfaces. The DMS 15 is also connected to a text service 25 that provides dynamic text to the dialogue management system from external sources, such as weather forecasts and current news headline feeds.

FIG. 4 shows the DMS 15 in further detail. It includes the dialogue manager 40 that generates responses. The dialogue manager includes a processor and a datastore. A sensors and UI interface 41 sits between the input/output devices and the dialogue manager in order to detect and pass signals to the dialogue manager 40 indicating events that have taken place. The dialogue manager 40 also receives its own responses as internal events, as it uses these as well as external events in determining further responses. An emotion manager 42 is coupled to the dialogue manager 40 to determine the appropriate emotions of the virtual host and generate responses in the appropriate form for the emotion. The emotion manager maintains and manages an emotional state which is affected by certain types of responses by the dialogue manager, and which in turn affects the priority of certain types of responses. A face/speech controller is provided 43 that receives the responses generated by the dialogue manager and directs the content including words, emotion and actions to the appropriate external systems. The customer data, which is retrieved and stored as part of the functionality, is used to generate special types of dialogue responses, such as when the name of the customer is inserted in a response. Information relating to past visits and/or favorite products could, for example, also be used in determining the response.

Description of System Operation.

Overview

A brief overview of the operation of the business management system 7, from the perspective of the customer, will now be described. A customer who wishes to purchase a drink enters the hotel bar. The business management system 1 detects the customer and greets them, by way of human animations and voice conveyed over the output devices. The host will then begin the transaction, such as by saying “Please swipe your hotel card”. At the point at which the customer does so the business management system 1 can retrieve personalised details of the customer from the records database 22 and from that point on customise their responses as required. The virtual host 50 will then continue to guide the customer through a transaction process, first inviting them to select a drink from the fridge then asking them to scan the barcode of the drink and then informing the customer of the price and asking for the payment method, be it by an electronic transaction method or by charging it to their hotel account. The virtual host 50 will communicate with the transaction system to effect the monetary transaction. During the process, the virtual host 50 will also carry out a conversation with the customer, perhaps talking about the weather or news, or asking them customer questions. The virtual host will then convey a pleasantry to the customer such as “Enjoy your drink” at which point the customer takes a seat in the hotel bar. The virtual host will then return to a “holding pattern” until another customer is detected.

The business management system 1 operation is based around the DMS 15 detecting “events”, determining appropriate responses to those events and then generating the responses for rendering on the output devices, such as the display 31 and audio speaker 30. The DMS 15 is a system for processing input events from various sources and determining, based on a set of rules, which response to perform at the present moment in time. In the context of this specification, an event is a unique occurrence at a particular moment in time, which may be caused by the environment (via environmental sensors), the customer (via the system's user interface) or by the system itself. For example, an event might be the customer entering the bar premises and being detected by the motion sensors. Another event could be the customer communicating information to the system, either by voice and/or the user interface. An event may also be something that is generated by the system itself. For example, a particular response determined by the system also becomes an event itself. This particular type of event is termed a “response event” which is an event generated by the dialogue management system when a response is performed. The response event contains the details of the response and is treated in the same way as any other event that is detected by the system. The business management system constantly monitors the events that occur, and determines what response, if any should be made in response to the events.

A response which is determined and generated by the system may take various forms. For example, it may be dialogue, information, an assertion or an instruction. Further, a response may be generated in response to an internal or other type of event which is not evident to the customer. A response is an output determined as appropriate given the current state of the dialogue, or events taking place in the rules at the present moment in time. The response may include any arbitrary content, which the application is capable of conveying to the user, as well as performing other response specific activities. Non-limiting examples of response content include a) text to be spoken audibly b) actions to be performed by an animated character, and c) information to display on a screen. Non-limiting examples of response-specific actions include a) updating a database record, b) adjusting the options available to the user in the systems user interface, c) altering the emotional state of the dialogue management system d) acquiring and translating content from an external system from outside the DMS, and e) the dialogue or information provided to the user on the output devices. These responses have the appearance of being unpredictable and spontaneous. For example, the DMS may cause the animated output to spontaneously comment on the number of sales of a particular drink (e.g. “I see lot's of people are drinking Coca Cola today”). In another example, the DMS may trigger the virtual host to comment on the weather (e.g. “I hope you've been enjoying the sun today”).

A rule is a particular condition, which determines whether to select and perform a response. Typically a rule will depend on the current state of the dialogue; however, an application-specific rule may include application-specific logic in its conditions. Rules may be combined together, such that the conditions of all of the combined rules must be satisfied in order to perform the response. Non-limiting examples of such conditions include (a) whether a particular set of events has occurred (or not occurred), (b) whether a specified amount of time has elapsed since a particular set of events has occurred (or not occurred), (c) whether a particular emotion is currently strong or weak, and (d) the current time of day.

An emotion (or “emotional state”) is a quantity that may be used to influence the selection of any given response. A non-limiting example of the emotions represented in the DMS are “anger”, “disgust”, “fear”, “joy”, “sadness”, and “surprise”. The relative strength or weakness of each emotion would form part of the conditions for selecting a particular response where the rules for that response specify a particular requirement for an emotional state (such as that the dialogue must be in a “joyful” state). A response may also alter any emotional state in order to influence future response selection.

A typical transaction that might take place between the virtual host and the customer follows.

A typical transaction that might take place between the virtual host and the customer follows.
1. When the customer walks into the bar area, the motion sensor sends the input event “MotionDetected” into the DMS;
2. The DMS selects and performs a “GreetUnknownCutomer” response;
3. The TTS (text-to-speech) system speaks the content of the response: “Hello! Please come over here and scan your room card.”
4. When the customer scans their room card, the card reader sends the input event “RoomCardScanned” into the DMS;
5. The DMS performs a single response “RetrieveCustomerData”;
6. The touch screen interface is updated to add a “cancel” button to allow the customer to terminate the interaction;
7. The DMS selects and performs a “GreetKnownCustomer” response;
8. The TTS system speaks the content of the response: “Great to see you again, Matthew!”;
9. The DMS selects and performs a “CommentOnTheWeather” response;
10. The TTS system speaks the content of the response: “It's great weather out there. I think it should be a nice night”;
11. After a short pause, the DMS selects and performs a “PromptExperiencedCustomerToGetDrinks” response;
12. The TTS system speaks the content of the response: “Well, you know the drill! Grab a drink from the fridge and bring to me”;
13. The DMS selects and performs a “FavouriteDrinkStock” response;
14. The TTS system speaks the content of the response: “There should be another two 350 ml Chardonnays in there”;
15. When the customer opens the fridge door, the fridge door sensor sends the input event “FridgeDoorOpened” into the DMS;
16. The DMS selects and performs a “EncourageCustomer” response;
17. The TTS system speaks the content of the response: “Take as many as you like”;
18. When the customer closes the fridge door, the fridge door sensor sends the input event “FridgeDoorClosed” into the DMS;
19. The DMS selects and performs a “PromptCustomerToScanDrinks” response;
20. The TTS system speaks the content of the response: “If that's all, come over here and scan your drinks”;
21. When the customer scans their drink, the barcode scanner sends the input event “ProductScanned” into the DMS;
22. The DMS performs a single response “RetrieveProductData”;
23. The touch screen interface is updated to add a “finish” button to allow the customer to complete the transaction;
24. The DMS selects and performs a “ReadbackProduct” response;
25. The TTS system speaks the content of the response: “That's one 350 ml Chardonnay”;
26. After a short pause, the DMS selects and performs a “PromptCustomerToGetMoreDrinks” response:
27. The TTS system speaks the content of the response: “If you want more drinks, please go and get them”
28. When the customer opens the fridge door again, the fridge door sensor sends the input event “FridgeDoorOpened” into the DMS;
29. The DMS selects and performs a “EncourageCustomerAfterOpeningFridgeAgain” response;
30. The TTS system speaks the content of the response: “Good on you! That's what I like to see!”
31. When the customer scans their drink, the barcode scanner sends the input event “ProductScanned” into the DMS;
32. The DMS performs a single response “RetrieveProductData”;
33. The DMS selects and performs a “ReadbackProduct” response;
34. The TTS system speaks the content of the response: “That's one bottle of beer”;
35. After a short pause, the DMS selects and performs a “PromptCustomerToPressFinish” response:
36. The TTS system speaks the content of the response: “If that's the lot, go ahead and press the finish button”
37. When the customer presses the finish button, the touch screen sends the input event “FinishPressed” into the DMS;
38. The DMS selects and performs a “ReadbackAllProducts” response;
39. The TTS system speaks the content of the response: “Ok, that's $10 for one 350 ml Chardonnay and one bottle of beer”;
40. The DMS selects and performs a “ThankCustomerForPurchase” response;
41. The TTS system speaks the content of the response: “Thanks for that! Your drinks have been put on your room account. You can visit again any time!”
42. The DMS selects and performs a “PromptCustomerToCloseFridge” response;
43. The TTS system speaks the content of the response: “Don't forget to close the fridge on your way out!”
44. When the customer closes the fridge door, the fridge door sensor sends the input event “FridgeDoorClosed” into the DMS;
45. The DMS selects and performs a “ThankCustomerForClosingFridge” response;
46. The TTS system speaks the content of the response: “You're a star! Thanks.” In the above example, the input events are:

MotionDetected: triggered by the motion sensor when it detects a presence;

RoomCardScanned: triggered by the card scanner when the customer scans their room card;

FridgeDoorOpened: triggered by the fridge door switch when the door is opened;

FridgeDoorClosed: triggered by the fridge door switch when the door is closed;

ProductScanned: triggered by the barcode scanner when the customer scans a product barcode;

FinishPressed: triggered by the touch screen when the customer presses the “finish” button

Detailed Operation

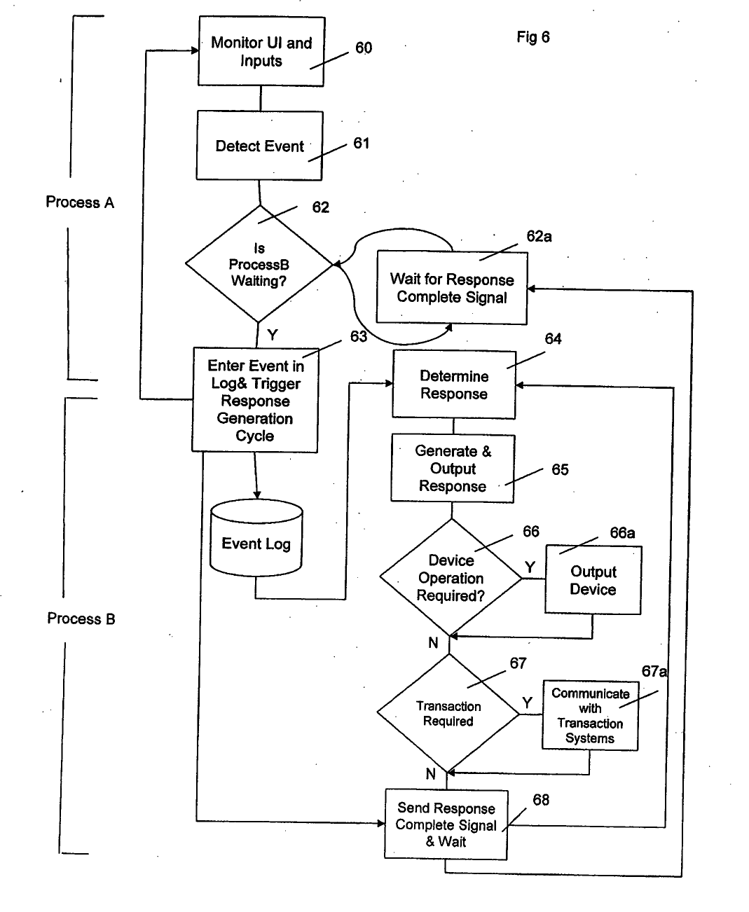

FIG. 6 shows the preferred general operation of the system 1 in more detail which results in a transaction, such as that described above. This is carried out in the DMS 15. As shown in step 60 (process A) the DMS 15 monitors the user interface and other input devices to determine if any external events have occurred. It also monitors internal events such as previous responses which have been conveyed to the customer. When an event is detected, step 61, the system then waits, step 62, 62a, until it has received a signal, from step 68, indicating that any current response being generated has been completed and the response generation cycle is complete. Once it is, preferably the system enters a record of the event in a log or other similar type of data structure (the “event log”) and then sends a signal to step 68 to immediately begin another response generation cycle, step 63. At this point, the monitoring and detection process (Process A), steps 60-63, continues—carrying on in parallel with the response generation process (Process B), steps 64-68.

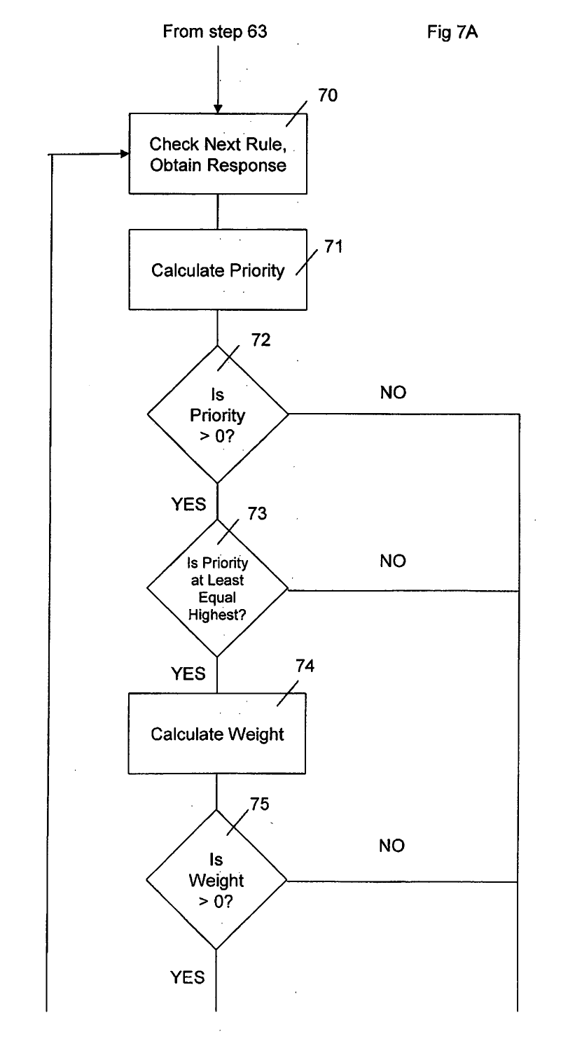

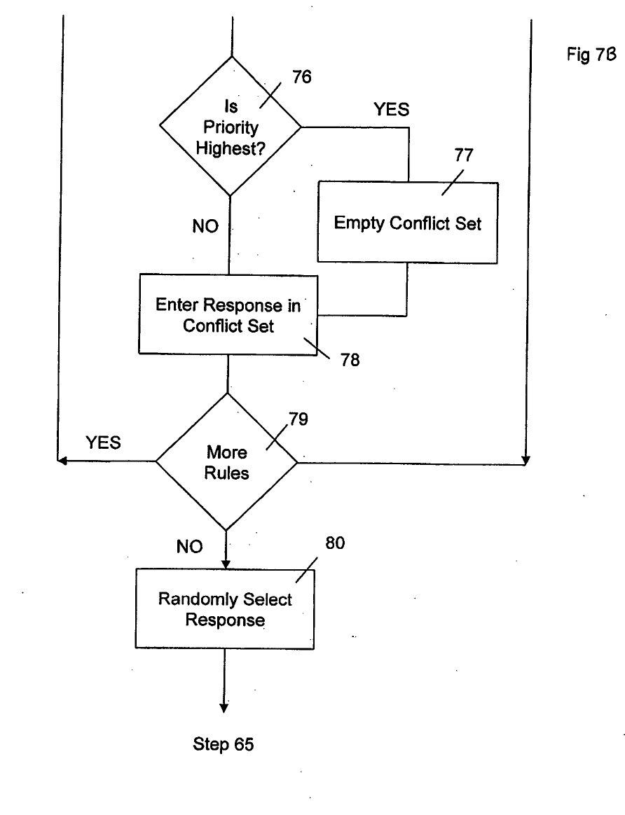

When a new response generation cycle is started (Process B), a response is determined, step 64, in a manner to be described in relation to FIG. 7. Once the DMS 15 selects an appropriate response, a response is generated and then output, step 65, using the output devices. For example, the human virtual host 50 could be rendered to give a particular dialogue response, which includes animating the virtual host on the screen 31, and outputting corresponding speech over the speaker 30. Text or other output can also be provided. A response might also include activating or otherwise operating one or more connected devices, such as the user interface touch screen 31, barcode scanner 37, customer card reader 36, motion sensor 34, refrigerator microswitch 35 and any other input devices are monitored. The self-service engine determines if any external devices require operation, step 66, and operates the device as required, step 66a. For example, this might be the opening of the refrigerator by way of the microswitch.

The system then determines whether or not the transaction system needs to be accessed, step 67, in order to conduct a transaction activity such as payment or updating account records. If so, the system communicates with the transaction system, step 67a, to carry out the steps. For example, it may be necessary to facilitate a credit card or electronic monetary transfer, update the accounting records, update the stock records, credit the room account with the purchase price, carry out a booking/reservation or similar activity after any particular point. To do so, the system 1 would pass customer information, price information payment card or account information and the like to the transaction systems 12, which would effect the transactions and update account records and the like as necessary.

In this particular example, the application communicates with the hotel booking/account system 21a at two times during a customer interaction:

When the customer scans their hotel card, the application sends a message to the hotel booking/account (transaction) system to retrieve the customer's booking details, including their name;

When the customer finishes a sale, the applications sends a message to the hotel booking/account system to add the total value of the sale to the customer's hotel account.

The application “posts” completed sales to the hotel booking/account system 21a asynchronously and periodically attempts to communicate with the hotel booking/account system 21a in order to update customers' accounts. When a customer “finishes” a sale, the sale is added to a queue for later processing. Usually, the hotel booking/account system 21a will be notified in less than a second, so the processing appears instantaneous. However, if the application cannot immediately notify the hotel booking/account system (e.g. it is shut down), it will retry every 10 minutes. Note that if the application itself is shut down, any sales that were still in the queue will be re-queued when it is restarted.

After completion of the response, and any related activities, the system 1 sends a response complete signal, step 68, back to the monitoring process at step 62a, indicating the response is complete and that the monitoring process can enter new events into the event log, step 63. At this point, the response generation process waits, also step 68, for either the next response generation cycle time or for a signal from step 63, and then goes back to step 64, to generate another response. Each complete iteration of the processes A and B, from event detection to response generation, form one step of a transaction, which may comprise a large number of iterations of steps 60-68.

These two processes A and B allow the following scenario, which effectively describes a “delayed response”:

Event A is detected and entered into the dialogue;

Time T elapses;

Response R is generated due to the combination of A and T (rather than A alone)

Alternative processes might be invoked which enable the following:

Event A is detected and entered into the dialogue;

Time T elapses;

Event B is detected and entered into the dialogue;

Response R is generated due to the combination of A and B.

There are two reasons why process B's step 68 will be completed (thus causing process B to restart):

A regular timeout (i.e. the beginning of the next pre-defined response generation cycle);

Detection of an input event (though indirectly), due to the timeout being triggered to occur immediately when the event is entered into the event log.

In process 2, the waiting and the timeout is occurring in step 68, after process A is “unblocked”, at steps 62, 62a. Step 68

will be completed when the timeout occurs

or when process B performs its step 63.

Rules Structure

Each time the DMS 15 selects and performs a response, as in the above example, it has applied the rules for that response to determine whether the state of the dialogue as represented by the event log is such that that response may be performed. As noted earlier, the state of the dialogue includes both the input events and the earlier responses (which are represented as response events, which are functionally equivalent to input events). The rules are used to determine whether the current state of the system (i.e. the dialogue up to this point) is such that it satisfies the conditions for a given response to be performed. Both the input provided to the system from the external world, and the responses previously given are used to determine if a response will be performed.

The set of rules that the DMS 15 applies to particular events to determine one or more appropriate responses are stored in a suitable file such as an XML file. The XML file defines the structure, rules and content for the dialogue, which is interpreted and performed by the DMS 15 Appendix A shows an example of a typical XML rules file, which includes a set of possible responses, and one or more rules for each response that are used to determine if those responses should be generated in response to a particular event. Appendix B shows a full explanation of the elements of the XML file.

The XML file defines the content and rules for each response. There are two types of response that may be defined:

A normal response (containing optional content);

An assertion (containing no content and with a maximum priority)

Assertions will occur before any normal responses. They may be used to simplify logic within the structure of the dialogue.

The basic structure of the XML file is as follows:

```
<dialogue>
  <responses>
    <response name=”Response1”>
      <!--Content and rule elements for Response1 here-->
    </response>
    <response name=”Response2”>
      <!--Content and rule elements for Response2 here-->
    </response>
    ...
  <assert name=”Assert1” collate=”true”>
    <event>...</event>
  </assert>
  <assert name=”Assert2” collate=”true”>
    <event>...</event>
  </assert>
  ...
  </responses>
</dialogue>
```

Each <response name=“response”></response> element identifies the rules for determining when the response should be generated, and it contains the content (or a reference to the content) that is to be generated. The content for a given response might include several equivalent alternatives, including generic content that can be combined with additional content, such as a customer name.

Other elements are also possible, such as assertions. In the context of the specification, these are also consider responses as they are generated in response to an event.

A “response” consists of the following:

Optional content that is output by the system (i.e. words, emotions, or actions);

Rules to determine whether the response is to be given

Response Selection

All rules for all responses in the system are checked several times per second to determine whether each response (associated with the rule) will be performed at that moment. The result of this is a candidate set of possible responses or “conflict set” containing the response or responses that can be performed. A conflict set is the set of responses that have been identified by the DMS 15 as having their conditions (rules) satisfied for being performed at the present moment in time. Where multiple responses are in the conflict set, one such response is randomly selected from the set and performed. The selection of the response to perform is determined by the priority and weight of each response in the set, with higher-priority responses being selected over lower-priority responses, and higher-weighted responses being more likely to be selected than lower-weighted responses.

The conflict set may contain:

No responses (nothing happens);

One response (this response is performed);

Several responses that can be performed (a single response is selected randomly and performed)

Where several responses apply at a particular moment, those responses form the conflict set. Only one response can be performed, so it is selected randomly from the conflict set and then performed. Note that a single response also forms the conflict set, which consists of one response that is always performed. Two factors influence which responses form the conflict set and which response is selected to be performed:

Priority;

Weight

A response with a higher priority will always be performed over a response with a lower priority. Only responses with the same priority may be part of the same conflict set, and responses with lower priorities are not considered.

A response with a higher weight is more likely to be performed over a response with a lower priority. If a response has a weight that is double the weight of another response, then that response is twice as likely to be performed as the response with the lower weight. Note that the weight of a response is only relevant in a conflict set that has more than one response.

The DMS 15 detailed in FIGS. 3 and 4 carries out the process for determining and generating appropriate responses to detected events (step 64 of FIG. 6) in accordance with the set of rules detailed above. FIG. 7 shows the selection step 62 of FIG. 6 in more detail.

As discussed earlier, the DMS 15 includes a datastore or file or similar that includes the set of rules specifying which responses should be generated in response to which events. It also includes a processor for accessing the datastore of rules and applying them at periodic intervals. The DMS 15 receives notification of detected events and stores these in a data structure in computer memory that represents a collection of such events (event log). When an event is passed to the response generation process, step 63 and step 64, the processor then accesses the datastore containing a set of rules determining which responses should be generated in relation to which events. It processes each rule in turn, step 70, to determine a response. In particular, it calculates the priority of the response using the rule, step 71, namely the priority of the response associated with the rule. If the priority is not above zero, step 72, or the priority is not at least equal to the current highest priority that has been calculated, step 73, the process skips to step 79. The processor then calculates the weight of the response, step 74, using the rule. If the weight is not above zero, step 75, then the process skips to step 79. If the priority is the sole highest priority, step 76, then the conflict set is emptied of all previous responses, step 77. Otherwise, the previous responses of equal priority remain in the conflict set. The current response, assuming it meets steps 72, 73 and 75, is placed in the conflict set, step 78. The process then reiterates, step 79, until all rules have been processed, and thus all possible responses have been considered. The processor then randomly selects, step 80, one of the responses from the conflict set, based on weighting, and passes it for generating or performing the response in the appropriate manner, e.g. by animation and voice output, (which is step 65 of FIG. 6). The random process is biased according to the weighting of each response in the conflict set, such that a response with a higher determined weighting has more chance of being selected than a response with a lower weighting.

The response which is selected could be any of the possible responses set out above, such as an assertion, dialogue, an instruction, provision of information or the like. Further the response may have a template structure which is designed for population with dynamic content. For example a greeting response may have the provision for including the customer's name, where known. The processor uses the definition of the response in the rule set to generate a response, including embedding any dynamic content. The generated response is then output to the face/speech controller 43, animator and synthesiser 32 for rendering on the output devices.

An alternative method could be provided, which is an adaptation of the method shown in FIG. 7. The next rule/response is obtained and the priority and weight are calculated. If the priority and weight are above zero (i.e. is the rule “satisfied”?), the response is entered into the conflict set. If there are still unprocessed rules, the next rule is processed. The highest priority for the responses in the conflict set is then determined and all responses from the conflict set that do not have the highest priority are removed. A response is randomly selected from the conflict set, and that response is generated/performed. The processor then waits a pre-determined time (or until an event is received an entered in the event log). The difference between these two is simply about whether the system avoids putting the lower-priority responses into the conflict set in the first place.

In these methods, the priority determines the order in which responses are performed (the higher priority responses are performed first) the weighting determines the probability of the response being selected (where a higher weight makes the response more likely). Each rule can manipulate either of these two values to adjust the order and/or the likelihood of the response ultimately being selected. Rules can also use either of these values to allow or prevent a response from being selected for a conflict set. Only responses whose priority and weight are both positive, non-zero numbers are entered into the conflict set. The rules are used to select the candidate set of possible responses to the event, which form the conflict set. In certain circumstances, no response may be suitable and in which case the conflict set will be null.

A rule could simply calculate a value in the following range (where “base” is a positive, non-zero number):

“0× base”, which would prevent the response from entering the conflict set; and

“1× base”, which would cause the response to enter the conflict set

Such a calculation would effectively be Boolean logic, where a particular condition is considered to be either false or true. Where the condition is false, the priority and/or weight number would be “0× base”, and where it is true the number would be “1× base”.

The following is an example of a rule and how it is used to determine priority and weight of a response, and thus determine whether a response will be selected. A commonly used rule is the “following” rule, which determines whether to allow a response depending on whether a trigger event has occurred or not. It does this by calculating the priority as either “0× base” or “1× base”. The logic for this rule is as follows:

Let T be a time in milliseconds in which a trigger event must have occurred;

Let R be the most recent delimiter event to have occurred (typically most recent event to have occurred with the same name as the response for this rule);

Let E be the most recent trigger event to have occurred;

If E occurred within T, and the sequence number for E is greater than that for R, then set priority to “1× base”; otherwise set priority to “0× base”

Consider the following sequence of events, where a “more recent” event has a higher sequence number:

1. InputEvent1

2. ResponseEventA

3. ResponseEventB

4. InputEvent2

5. ResponseEventA

Now consider the following available responses (where they delimit themselves and where “T” is a trigger event, “BP” is the “base priority” and “BW” is the “base weight” for each response):

ResponseEventA: T=InputEvent1 or T=InputEvent2; BP=5; BW=1;

ResponseEventB: T=ResponseEventA, BP=3; BW=3;

ResponseEventC: T=InputEvent2, BP=3; BW=2;

ResponseEventD: T=ResponseEventA, BP=1; BW=1;

In calculating the priority for each response, the formula “1× base” would be used where the response can occur given the current sequence of events, and “0× base” where it cannot. Note that in this case, the value of “base” is the “base priority” (BP).

Given the sequence of events, and using the “following” rule we can determine that:

ResponseEventA cannot occur because InputEvent1 and InputEvent2 have not occurred since the last ResponseEventA;

ResponseEventB can occur because ResponseEventA has occurred since the last ResponseEventB;

ResponseEventC can occur because InputEvent2 has occurred since the beginning of the dialogue (since ResponseEventC not yet occurred);

ResponseEventD can occur because ResponseEventA has occurred since the beginning of the dialogue (since ResponseEventD not yet occurred).

We can now calculate the current priorities for each of these responses:

ResponseEventA: (0×BP): 0×5=0;

ResponseEventB: (1×BP): 1×3=3;

ResponseEventC: (1×BP): 1×3=3;

ResponseEventD: (1×BP): 1×1=1

The conflict set will contain only those responses that have the highest calculated priority, where that priority is above zero, and that have a weight that is also above zero. The highest calculated priority is 3, which is above zero, and which is the calculated priority for both “ResponseEventB” and “ResponseEventC”. Note that the rules do not adjust the base weights, and the base weights are also all above zero. Therefore the conflict set will contain both of these responses.

The formation of the conflict set can be achieved using the following which is a summary method of the method set out in relation to FIG. 7:

a) Obtain next response;

b) Calculate its priority;

c) If the priority is not above zero, skip to step (i);

d) If the priority is not at least equal to the highest priority calculated thus far, skip to step (i);

e) Calculate its weighting;

f) If the weighting is not above zero, skip to step (i)

g) If the priority is the highest priority calculated thus far, empty the conflict set

h) Enter the response into the conflict set;

i) If there are still unprocessed rules, return to step (a);

Here is the sequence of steps using the algorithm that generates the conflict set determined above to contain “ResponseEventB” and “ResponseEventC”:

a) Process ResponseEventA;

b) Calculate priority to be 0×5=0;

c) The priority is not above zero, so skip to step (i)

. . .

i) There are still unprocessed rules, so return to step (a);

. . .

a) Process ResponseEventB;

b) Calculate priority to be 1×3=3;

c) The priority is above zero, so continue to step (d);

d) The highest priority thus far is 0 and 3 is at least equal to 0, so continue to step (e);

e) The weight is 3;

f) The weight is above zero, so continue to step (g);

g) 3 is the highest priority calculated thus far, so empty the conflict set;

h) The conflict set now contains ResponseEventB;

i) There are still unprocessed rules, so return to step (a);

. . .

a) Process ResponseEventC;

b) Calculate priority to be 1×3=3;

c) The priority is above zero, so continue to step (d);

d) The highest priority thus far is 3 and 3 is at least equal to 3, so continue to step (e);

e) The weight is 2;

f) The weight is above zero, so continue to step (g);

g) 3 is not the highest priority calculated thus far, so retain the existing conflict set;

h) The conflict set now contains ResponseEventB and ResponseEventC;

i) There are still unprocessed rules, so return to step (a);

. . .

a) Process ResponseEventD;

b) Calculate priority to be 1×1=1;

c) The priority is above zero, so continue to step (d);

d) The highest priority thus far is 3 and 1 is not at least equal to 3, so skip to step (i);

. . .

i) There are no unprocessed rules, so finish the algorithm

Because the conflict set contains more than one item, we must now randomly select one using their weights to bias the selection. The probability of each response is given as W/T, where “W” is the weight of the response, and “T” is the total sum of the weights of all responses in the conflict set.

In the current conflict set the total sum of the weights is 3+2=5. Thus, the probability of each response is:

ResponseEventB: 3/5=0.6;

ResponseEventC: 2/5=0.4;

Note that in this case there are no rules that impact on the weight of the responses. Therefore, in calculating the probability for each response, the “base weight” value is used unchanged.

Rules can be combined in series to create a compound rule, where the priority and weight values calculated by each rule are used as input into the next rule. For example, consider “base” to be the base priority or weight, “output” to be the final value calculated, and “R1 . . . R3” to be the priority calculated by each rule in the series:

Base=10;

R1=Base×2;

R2=R1×0.4;

R3=R2×1.1

Output=R3=8.8

Using the example given earlier, we could implement a new response with a compound rule as follows:

ResponseEventE: T=ResponseEventA and T=InputEvent3 and T=ResponseEventB; BP=10

For this response there are three “following” rules in series, which check for “ResponseEventA”, “InputEvent3” and “ResponseEventB” respectively. The priority for “ResponseEventE” would therefore be calculated as follows:

Base=10;

R1=Base×1 (as ResponseEventA has occurred);

R2=R1×0 (as InputEvent3 has not occurred);

R3=R2×1 (as ResponseEventB has occurred);

Output==R3=0 (as 10×1×0×1=0)

Therefore, “ResponseEventE” would not be included in the conflict set as its calculated priority is zero (i.e. it is not a positive non-zero number).

Referring now to the particular example set out earlier, in the case of the “GreetKnownCustomer” response, the rules for performing that response would include:

“RetrieveCustomerData” response has just occurred;

“RetrieveCustomerData” has only occurred once.

Variations on the “GreetKnownCustomer” response could also be constructed. For example, instead of a single “GreetKnownCustomer”, we may have “G reetKnownCustomer-LastVisitToday”, “GreetKnownCustomer-LastVisitYesterday” and “GreetKnownCustomer-LastVisitBeforeYesterdayOrNever”. These more specific responses allow more specific content. In each of these cases the rules would include suitable additional conditions, for example (respectively):

Customer last visited today;

Customer last visited yesterday; and

Customer last visited before yesterday or has never visited before.

Additionally there may be variations in content available for a given type of response. For example, for “GreetKnownCustomer”, there may be the functionally equivalent content:

“Hi Matthew!”

“Hello, good to see you Matthew”

“It's great to see you, Matthew”

As noted above, where there are different content available or different types of responses available, a conflict set is formed, from which one response will be randomly selected. For example, a conflict set following the “RetrieveCustomerData” response event may be:

“GreetKnownCustomer” with content “Hi Matthew”;

“GreetKnownCustomer” with content “Hello, good to see you Matthew”;

“GreetKnownCustomer” with content “It's great to see you, Matthew”;

“GreetFavouriteCustomer” with content “Ah, it's my favourite customer!”

From these four possible responses, one will be selected. Which one is selected depends on two factors: its priority, and its weight.

If all responses have the same priority of 1 and weight of 1, then the probability of each response being selected from the set is 25% (or ¼, where 1 is the weight and 4 is the sum of the weights of all the responses). However, if the “GreetFavouriteCustomer” response instead had a weight of 2 (and the “GreetKnownCustomer” responses each had a weight of 1) then the probability of the “GreetFavouriteCustomer” would be 40% (or ⅖) and each “GreetKnownCustomer” response would be 20% (or ⅕).

Priority has the effect of excluding responses from the conflict set that do not have the highest priority. If the “GreetFavouriteCustomer” response had a priority of 2 and the “GreetKnownCustomer” each had a priority of 1, then the highest priority in the conflict set would be 2, and all of the responses that have a priority of less than 2 would be excluded. In this case, only “GreetFavouriteCustomer” would be in the conflict set once the priority had been taken into account. Note that the weighting of the responses in the conflict set is used to bias response selection only once the lower-priority responses have been removed (leaving only responses with the highest priority in the set).

The DMS generates the response by accessing a file referred to in the associated rule, the file containing content (such as text, animations etc.) that is used to generate the response. For example, when a text response is selected, the rule refers to a file containing one or more lines of text and, as a response-specific action, will randomly select a single line from that file for use as the content for the current response. Note that this random selection of content performed as a response-specific action occurs after the response has been selected from the conflict set, and it is unrelated to the earlier random selection of the current response from the conflict set. This random selection provides for a simple method of randomising the content for a given response (where each alternative content is functionally equivalent) without having to configure multiple alternate responses for each alternative content and using the conflict set to select one such response). The “<text>” element in the dialogue XML file instructs the DMS to load the content from a file that bears the name of the response (with the appropriate language suffix). Thus, for example, the “CustomerSelectedEvent_GreetTheCustomer#Default” response has a “<text> element, which instructs the DMS to load a file called “CustomerSelectedEvent_GreetTheCustomer#Default_en.txt” from the computer's disk drive (where “_en” is replaced by the appropriate language code if the current language is other than English—e.g. “CustomerSelectedEvent_GreetTheCustomer#Default_fr.txt” would be the French equivalent).

The file would contain the following, one of which would be selected and conveyed, either as text or as text-to-speech:

Welcome back {customer}!

I hope you've been having a good time {customer}!

I hope you've been enjoying yourself {customer}!

Hello again {customer}!

So you're back for more {customer}!

Great to see you again {customer}!

Not you again.:

Gidday {customer}!

Hi {customer}, good to see you again.

Hi, I'm {barmaid-name}, the virtual barmaid for the Monaco Hotel and Resort. If you want to buy drinks from the self serve bar, I'm the one to talk to, day or night.

So you've never met a virtual barmaid before? My name is {barmaid-name} and I'm here to help.

We thought we'd have a bit of fun so instead of an over-worked barmaid you get me. {barmaid-name} the virtual barmaid.:0.1

Hello {customer}!

Hi {customer}!

Good {period-of-day} {customer}!

Hey {customer}!

{customer}!

It's great to see you {customer}!

It is appreciated that the above example is just one of many examples of such an interaction. Variations in the text spoken by the TTS may occur each time that the DMS selects a response, and some responses may not be relevant to some customers (e.g. “PromptExperiencedCustomerToGetDrinks” would only be in the conflict set if the customer had previously used the system several times recently).

Additionally, the order of input events may change (e.g. a drink may be scanned before the room card is scanned), which would result in a significantly different dialogue path.

A large number of different types of responses could be generated, for example, such as illustrated in the example in relation to FIG. 6.

Emotion Manager

The DMS 15 maintains an internal, dynamic model of an emotional state by way of the emotion manager 42. The purpose of maintaining this state is to provide a mechanism for modelling human emotions in order to add realism to an interaction with a customer. The emotions can be used to influence the response selection, and also influence the manner in which a particular response is rendered. An emotion can be used to:

Affect the speech characteristics of a text-to-speech (TTS) system;

Affect the facial pattern and body movements of an animated character;

Make certain responses more or less likely to occur during a dialogue.

The DMS 15 allows for an arbitrary number of separate emotional states to be modeled simultaneously. Due to the use of facial animation, however, the use of the six fundamental facial emotions is preferred. These are:

Anger

Disgust

Fear

Joy

Sadness

Surprise

Each separate emotional state (such as “joy”, “anger”, “sadness” and so on) is stored as a current weighting and a target weighting. The current weighting may also be represented as a relative weighting, in the range 0.0-1.0, when compared to the other emotional states in the system. For example, in the case of a two-state system consisting of “joy” and “sadness”, if “joy” were to have a current weight of 3 and “sadness” a current weight of 2, then the relative weight of each would be 60% and 40% respectively (i.e. ⅗ and ⅖). As each response is performed by the DMS 15, the emotional state may be updated by adjusting the target weighting for each state. A response may cause the target weights of the emotional states to change:

To an arbitrary absolute value;

By a fixed absolute amount; or

By a relative amount or percentage.

The emotional state's current absolute weight will move towards the new target weight over a particular period of time, as specified by the response (which may be quickly or slowly). The curve followed by the absolute weight as it changes may be a flat line, so as to provide a steady change, or it may be curved, so as to provide a period of more rapid change. Once the target is reached it will be automatically reset to neutral (i.e. the target becomes 0) with a very slow rate of change. This will, over a period of time, and without any further changes to the targets, eventually return overall state to the neutral. The emotional state system may be used to influence the response weighting calculations during response selection in the DMS. The DMS will examine the current emotional state while it is determining a response (Step 64 of FIG. 6).

A response's weight may be adjusted by the relative weight of a particular emotion according to the formula:
weight=[base weight]×[emotion relative weight]×[factor]

In this formula, the “base weight” is the weight that is to be adjusted, the “emotion relative weight” is the current relative weight of the particular emotion (in the range 0.0-1.0), and the “factor” is an arbitrary multiplier. By affecting the response weight in this way, a response can be made more or less likely to be selected during response selection.

The following algorithm (A) maintains the overall emotional state:

a) Obtain the next emotional state;

b) If the weight is not changing, skip to step (d);

c) Update the actual weight to be the expected weight at the current time;

d) If there are more emotional states, return to step (a);

e) Wait until the next update cycle

Note that the update cycle is typically every few milliseconds. The calculation for determining the expected weight is (where “change amount” is the amount by which to change the weight, and “change time” is the duration in which the change must be completed):
weight=[target]−[change amount]+(P×[change amount])
P=[time since last cycle]/[change time]
Staff Interaction

Staff interaction occurs through the use of a special hotel card. This card is scanned in the same way that the customer would scan their hotel card. When the staff card is scanned, a code entry screen appears. Staff can use this screen to enter a function code to perform any one of the following actions:

Select a customer by manually entering a customer's booking reference (as if the customer had scanned their hotel card) or their room number;

Select a product by manually entering a product barcode (as if the product's barcode was scanned);

Suspend or resume the application;

Reprint the last receipt for a specified customer (if none is active), or the customer that is currently active in the dialogue;

Exit the application (return to Windows)

If a function requires an additional number (e.g. selecting a customer or product), another screen similar to the code entry screen will appear to allow the user to enter the number. In the case of selecting a product, the screen will remain visible until the user pressed the “abort” button (to allow the user to select more than one product).

The application can be suspended to prevent customers from using it. This may be used if the product database is being updated, or sales cannot be completed at the present time. The screen prompts the customer to either wait or seek staff assistance. The application may be suspended by:

Suspending it from the management application;

Suspending it using the staff function code;

The application may be resumed by:

Resuming it from the management application;

Resuming it using the staff function code

If the application encounters a problem and it cannot continue, an “out of order” message is displayed prompting the user to seek staff assistance. A staff member must correct the problem and resume the application. It may be necessary to view the Windows event log for error messages relating to the problem.

Problems that may cause an “out of order” message include:

Unable to connect to database or hotel booking/reservation system;

Unable to read/missing dialogue XML or text file;

Unable to open a TCP/IP port (e.g. for the management application)

Management Application

The management application provides the staff with facilities for maintaining the product database and viewing reports. It can interact with the main application and provides a means to remotely control the main application. The management application communicates with the main application via a text-based interface that operates on the default port of 7777. This interface can be accessed using a “telnet” client, if necessary.

There are several screens available within the management application for displaying information about the system. These are described in the sections below.

The status screen displays details about the current status of the main application. It shows:

The current failure (i.e. “Suspended” or “OutOfOrder”), or “None” if the application is running normally;

Whether the application is in use (i.e. a customer has been detected);

The name of the current customer (if a hotel card has been scanned);

The name of the last customer;

The length of time that the main application has been running

It also allows the user to remotely suspend the main application, or resume the application if it is suspended or has failed. Note that if the user clicks the “suspend” button, and the application is in use, a warning message will be displayed.

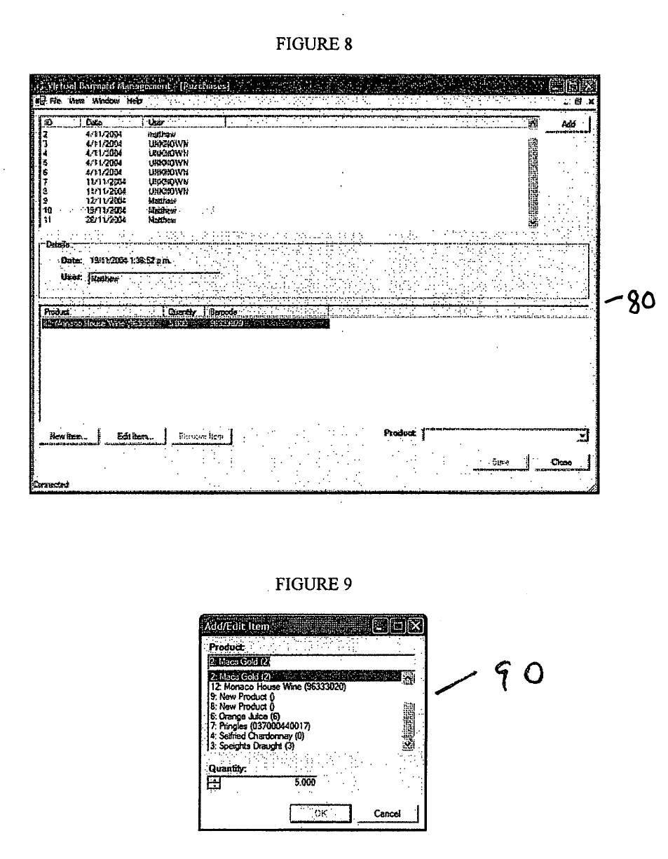

A “purchases” screen 80 (see FIG. 8) allows the user to record a purchase of stock into the system. Purchasing stock increases the stock on hand of the product that is purchased. The screen allows the user to “add” a new purchase using the “add” button at the top right or edit existing purchases, which are displayed in the “purchases list” at the top. When a purchase is selected in the “purchases list”, its details are displayed at the bottom of the screen, including each product that is in the purchase. Items can be added to the purchase by pressing the “new item” button, or by selecting a product from the “product” combo box at the lower right of the screen (every time a product is selected from the combo, its purchase quantity is incremented by one). Note that a barcode scanner can also be used to scan products into the combo box. The user can set the quantity of an item explicitly or change the product of a new item by pressing the “edit item” button. This displays the “add/edit item” dialog window 90 (see FIG. 9) that allows the item's product to be selected (if the item is new) and the quantity to be set. The products available in the dialog window are only the products that are not already in the purchase. If all products are already in the purchase, the product list in the dialog window will be empty. If the item is new, the user can also remove it from the purchase by pressing the “remove item” button. Once the user has finished editing the purchases he can press the “save” button to save the changes to the database. Alternately, the user can press the “close” button to discard the changes made (a warning will be shown, if any changes have been made).

A “stocktake/adjustments” screen allows the user to enter adjustments (other than purchases) into the system. An adjustment will adjust the level of stock, either up or down. When used for stocktakes, the user enters the quantity by which to adjust the amount of stock on hand. For example, if the stock is found to be down by two items, the quantity is entered as “−2”. The screen is identical to that of the “purchases” screen in both function and appearance.

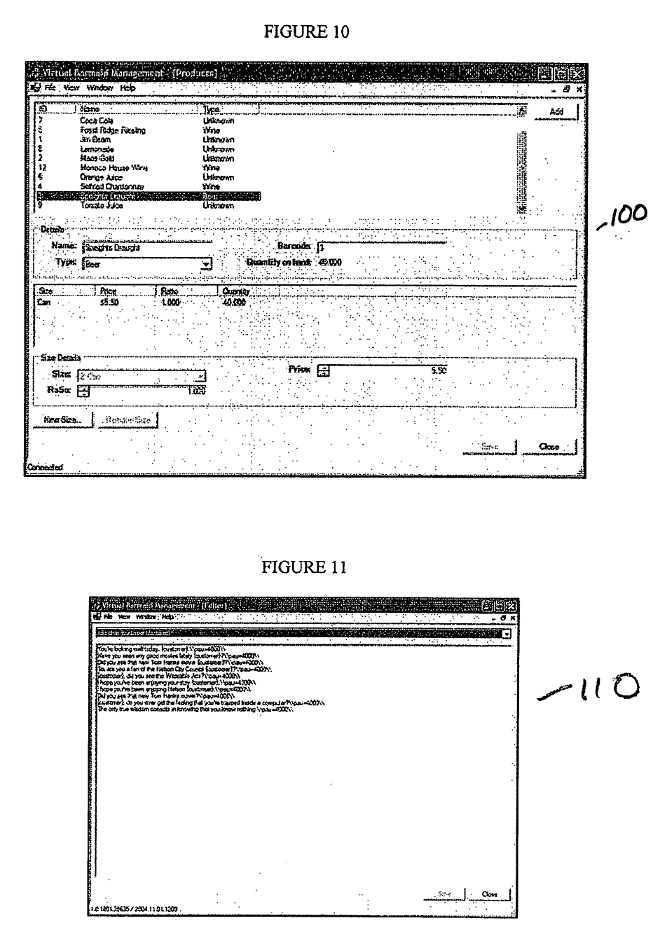

A products screen 100 (see FIG. 10) allows maintenance of the products in the system. Once a product has been entered into the system, it becomes available to the main application. The products list at the top shows the products that are defined within the system. New products may be added by pressing the “add” button at the top right. The product details are entered into the details section in the middle and the sizes defined at the bottom. Note that most products will only have one size.

The list of products is colour-coded to help identify which products are in stock, and which products need restocking. The coding is as follows:

Bold grey text: the item is deleted and has a non-zero quantity on hand

Bold, blue text: the item has a quantity on hand >0 (i.e. should be in the bar)

Bold, red text: the item has a quantity on hand <0 (i.e. more units sold than should have been)

Regular grey text: the item is deleted

Regular black text: the item is not deleted and has zero quantity on hand

Each size shows the quantity of that size that is available, given the overall quantity of the product and the ratio of the size. For example, if a size has a ratio of 0.5, and the product quantity is 10, the size quantity will be 20 (10/0.5). To add a new size to the product, the user presses the “new size” button. This causes the next available size to be added, and the user can select the size using the size combo. Sizes can also be removed, though at least one size must remain defined. Note that attempting to remove a size that has been sold will cause an error to occur when the “save” button is pressed.

Once the user has finished editing the products he can press the “save” button to save the changes to the database. Alternately, the user can press the “close” button to discard the changes made (a warning will be shown, if any changes have been made). Note that if the main application is in use, a warning message will be displayed when the user attempts to save changes to the products. Changing the products while the main application is in use is not recommended and may cause the transaction to fail with an “out of order” message. It is recommended that the user suspend the main application while performing product maintenance by using the “status” screen.

Several reports are available that allow the user to view details of the products in the system and sales that have occurred. The reports include:

“Sales” report, showing the quantity of each product sold during a period;

“Product” report, showing the quantity on hand for each size of each product as at the current time;

“Product activity” report, showing the quantity sold, purchased and adjusted during a period

The editor 110 (see FIG. 11) allows the user to edit the static dialogue text for certain dialogue events that occur. Refer to the documentation for the dialogue XML for further details on the format of this text.

As noted above, the description primarily relates to one implementation of the invention, namely in a hotel bar premises. The invention could also be implemented in a range of other situations. For example, in a retail outlet the self-service engine could be integrated with the retail outlet's purchase and accounting systems. The customer could approach the self-service engine, be greeted and then request information on a certain item. The virtual host could then direct the user to the item and provide information about the item's availability and features. During the whole process, the virtual host will provide dialogue, instructions, information, assistance and friendly exchanges replicating what would normally take place if a human customer service would. Yet other variations would be apparent to those skilled in the art.

It will be appreciated that the nature of the responses defined in the XML can vary depending on the particular industry in which the self-service engine is implemented. For example, in a retail outlet, a response could provide information on particular products or services in response a customer query. Particular products or services could also be offered to a customer based on customer data from previous visits. That is, there may be a response based on customer loyalty or a customer profile. This could extend to the nature of the responses being tailored based on the customer profile.

It will be appreciated that the invention is not restricted to the particular operational methods set out in FIGS. 6 and 7. The actual order and manner in which events are processed, rules applied, priorities/weightings determined and conflict sets determined could alter.

```
APPENDIX A
        - <!--
        Virtual Barmaid dialogue definition for “CustomerSelectedEvent”
    -->
- <dialogue>
- <responses>
  - <!--
    BEGIN CustomerSelectedEvent
    -->
  - <!--
    Set the customer
    -->
- <response name=“CustomerSelectedEvent_SetCustomer” basepriority=“20”
    interruptlevel=“20”>
- <following delimiter=“CustomerSelectedEvent_Completed”>
  <event>CustomerSelectedEvent</event>
    </following>
  <customerselected mode=“first” />
  <setcustomer />
    </response>
  - <!--
    Perform initial greeting
    -->
- <response name=“CustomerSelectedEvent_GreetTheCustomer#Default”
      interruptlevel=“1”>
  <text />
  <emotion type=“happy” weight=“+4” />
  <emotion type=“sad” weight=“−10” />
  <emotion type=“anger” weight=“−10” />
- <following delimiter=“CustomerSelectedEvent_Completed”>
  <event>CustomerSelectedEvent_SetCustomer</event>
    </following>
  <customerselected mode=“first” />
    </response>
- <response name=“CustomerSelectedEvent_GreetTheCustomer#SameAsLast”
    interruptlevel=“1”>
  <text />
  <emotion type=“happy” weight=“+4” />
  <emotion type=“sad” weight=“−10” />
  <emotion type=“anger” weight=“−10” />
- <following delimiter=“CustomerSelectedEvent_Completed”>
  <event>CustomerSelectedEvent_SetCustomer</event>
    </following>
  <customerselected mode=“firstsameaslast” />
    </response>
  - <response name=“CustomerSelectedEvent_GreetTheCustomer#VeryRecent”
    interruptlevel=“1”>
  <text />
  <emotion type=“happy” weight=“+6” />
  <emotion type=“sad” weight=“−10” />
  <emotion type=“anger” weight=“−10” />
- <following delimiter=“CustomerSelectedEvent_Completed”>
    <event>CustomerSelectedEvent_SetCustomer</event>
    </following>
  <customerselected mode=“first” />
  <customerprevioususe mode=“veryrecent” />
    </response>
- <response name=“CustomerSelectedEvent_GreetTheCustomer#SemiRecent”
    interruptlevel=“1”>
  <text />
  <emotion type=“happy” weight=“+8” />
  <emotion type=“sad” weight=“−10” />
  <emotion type=“anger” weight=“−10” />
- <following delimiter=“CustomerSelectedEvent_Completed”>
  <event>CustomerSelectedEvent_SetCustomer</event>
    </following>
  <customerselected mode=“first” />
  <customerprevioususe mode=“semirecent” />
    </response>
- <response name=“CustomerSelectedEvent_GreetTheCustomer#NotRecent”
    interruptlevel=“1”>
  <text />
  <emotion type=“happy” weight=“+10” />
  <emotion type=“sad” weight=“−10” />
  <emotion type=“anger” weight=“−10” />
- <following delimiter=“CustomerSelectedEvent_Completed”>
  <event>CustomerSelectedEvent_SetCustomer</event>
    </following>
  <customerselected mode=“first” />
  <customerprevioususe mode=“notrecent” />
    </response>
- <assert name=“CustomerSelectedEvent_GreetTheCustomer” collate=“true”>
  <event>CustomerSelectedEvent_GreetTheCustomer#Default</event>
  <event>CustomerSelectedEvent_GreetTheCustomer#SameAsLast</event>
  <event>CustomerSelectedEvent_GreetTheCustomer#VeryRecent</event>
  <event>CustomerSelectedEvent_GreetTheCustomer#SemiRecent</event>
  <event>CustomerSelectedEvent_GreetTheCustomer#NotRecent</event>
      </assert>
  - <!--
    Instruct the customer
    -->
- <response name=“CustomerSelectedEvent_TellCustomerAboutSystem”
      basepriority=“2”>
  <text />
- <following delimiter=“CustomerSelectedEvent_Completed”>
  <event>CustomerSelectedEvent_GreetTheCustomer</event>
    </following>
  <productrecorded mode=“none” />
  <customerprevioususe mode=“none” />
    </response>
- <response name=“CustomerSelectedEvent_PromptCustomerToGetDrinks1”>
  <text />
- <following delimiter=“CustomerSelectedEvent_Completed”>
  <event>CustomerSelectedEvent_TellCustomerAboutSystem</event>
    </following>
    </response>
- <response name=“CustomerSelectedEvent_PromptCustomerToGetDrinks2”>
  <text />
- <following delimiter=“CustomerSelectedEvent_Completed”>
  <event>CustomerSelectedEvent_GreetTheCustomer</event>
    </following>
  <productselected mode=“none” />
  <productrecorded mode=“none” />
  <customerprevioususe mode=“any” />
    </response>
- <response name=“CustomerSelectedEvent_PromptCustomerToGetDrinks”>
  <text />
- <countevents collate=“true”>
  <event>CustomerSelectedEvent_PromptCustomerToGetDrinks1</event>
  <event>CustomerSelectedEvent_PromptCustomerToGetDrinks2</event>
    </countevents>
    </response>
  - <!--
    Readback a single product that was scanned prior to the customer being
      identified
    -->
- <response name=“CustomerSelectedEvent_ReadbackProduct”>
  <text />
- <following delimiter=“CustomerSelectedEvent_Completed”>
  <event>CustomerSelectedEvent_GreetTheCustomer</event>
    </following>
  <productselected mode=“one” />
  <productrecorded mode=“any” />
    </response>
- <response name=“CustomerSelectedEvent_PromptCustomerToScanMoreDrinks”>
  <text />
- <following delimiter=“CustomerSelectedEvent_Completed”>
  <event>CustomerSelectedEvent_ReadbackProduct</event>
    </following>
    </response>
  - <!--
    Instruct the user to scan all their drinks (as they scanned more than one
    before being identified)
    -->
- <response name=“CustomerSelectedEvent_PromptCustomerToScanAllDrinks”>
  <text />
- <following delimiter=“CustomerSelectedEvent_Completed”>
  <event>CustomerSelectedEvent_GreetTheCustomer</event>
    </following>
  <productselected mode=“several” />
    </response>
- <response name=“CustomerSelectedEvent_PromptCustomerToScanAllDrinks”>
  <text />
- <following delimiter=“CustomerSelectedEvent_Completed”>
  <event>CustomerSelectedEvent_GreetTheCustomer</event>
    </following>
  <productselected mode=“one” />
  <productrecorded mode=“none” />
    </response>
  - <!--
    Provide a transaction summary if the customer scans their card again and
      provide instruction to finish
    -->
- <response name=“CustomerSelectedEvent_TransactionSummary”>
  <text />
- <following delimiter=“CustomerSelectedEvent_Completed”>
  <event>CustomerSelectedEvent</event>
    </following>
- <following delimiter=“CustomerSelectedEvent_GreetTheCustomer”>
  <event>CustomerSelectedEvent</event>
    </following>
  <customerselected mode=“duplicate” />
    </response>
- <response name=“CustomerSelectedEvent_PromptToFinish1”>
  <text />
- <following delimiter=“CustomerSelectedEvent_Completed”>
  <event>CustomerSelectedEvent_TransactionSummary</event>
    </following>
  <productrecorded mode=“any” />
    </response>
- <response name=“CustomerSelectedEvent_PromptToFinish2”>
  <text />
- <following delimiter=“CustomerSelectedEvent_Completed”>
  <event>CustomerSelectedEvent_TransactionSummary</event>
    </following>
  <productrecorded mode=“none” />
    </response>
- <response name=“CustomerSelectedEvent_PromptToFinish”>
  <text />
- <countevents collate=“true”>
  <event>CustomerSelectedEvent_PromptToFinish1</event>
  <event>CustomerSelectedEvent_PromptToFinish2</event>
    </countevents>
    </response>
  - <!--
    Different customer card scanned so charge any products to the old customer
      and reset to the new customer
    -->
- <response name=“CustomerSelectedEvent_CustomerIsDifferent”>
  <text />
- <following delimiter=“CustomerSelectedEvent_Completed”>
  <event>CustomerSelectedEvent</event>
    </following>
  <customerselected mode=“different” />
    </response>
- <response
    name=“CustomerSelectedEvent_ChargeRecordedProductsToHotelAccount”
    basepriority=“2”>
  <text />
- <following delimiter=“CustomerSelectedEvent_Completed”>
  <event>CustomerSelectedEvent_CustomerIsDifferent</event>
    </following>
  <productselected mode=“any” />
  <chargeproducts />
    </response>
- <response name=“CustomerSelectedEvent_CreateNewDialogue”>
  <text />
- <following delimiter=“CustomerSelectedEvent_Completed”>
  <event>CustomerSelectedEvent_CustomerIsDifferent</event>
    </following>
  - <!--
    Note: this setcustomer causes the current dialogue to reset
    -->
  <setcustomer mode=“resetdialogue” />
    </response>
- <assert name=“CustomerSelectedEvent_Completed” collate=“true”>
  <event>CustomerSelectedEvent_PromptCustomerToGetDrinks</event>
  <event>CustomerSelectedEvent_PromptCustomerToScanAllDrinks</event>
  <event>CustomerSelectedEvent_PromptCustomerToScanMoreDrinks</event>
  <event>CustomerSelectedEvent_PromptToFinish</event>
  <event>CustomerSelectedEvent_CreateNewDialogue</event>
    </assert>
  - <!--
    END CustomerSelectedEvent
    -->
  </responses>
  </dialogue>
```

### APPENDIX B

### Dialogue Manual

### Rule-Based System

The dialogue.xml file defines the structure, rules and content for the dialogue, which is interpreted and performed by the DialogueManager. The dialogue is a “rule-based system”, in which the response to perform at any particular moment is determined by the set of rules defined for that response.

The rules are used to determine whether the current state of the system (i.e. the dialogue up to this point) is such that it satisfies the conditions for a given response to be performed. Both the input provided to the system from the external world, and the responses previously given are used to determine if a response will be performed.

A “response” consists of the following:
Optional content that is output by the system (i.e. words, emotions, or actions);
Rules to determine whether the response is to be given

Note that performing a given response may immediately trigger further responses if that response is a prerequisite for the other responses.

Performing a Response

All rules for all responses in the system are checked several times per second to determine whether each response will be performed at that moment. The result of this is a “conflict set” containing the response or responses that can be performed. The “conflict set” may contain:
No responses (nothing happens);
One response (this response is performed);
Several responses that can be performed (a single response is selected randomly and performed)

Where several responses apply at a particular moment, those responses form the conflict set. Only one response can be performed, so it is selected randomly from the conflict set and then performed.

Note that a single response also forms the conflict set, which consists of one response that is always performed.

Two factors influence which responses form the conflict set and which response is selected to be performed:
Priority;
Weight

A response with a higher priority will always be performed over a response with a lower priority. Only responses with the same priority may be part of the same conflict set, and responses with lower priorities are not considered.

A response with a higher weight is more likely to be performed over a response with a lower priority. If a response has a weight that is double the weight of another response, then that response is twice as likely to be performed as the response with the lower weight. Note that the weight of a response is only relevant in a conflict set that has more than one response.

Basic XML Structure

The dialogue.xml file defines the content and rules for each response. There are two types of response that may be defined:
A normal response (containing optional content);
An assertion (containing no content and with a priority of 99)

Assertions will occur before any normal responses that have a priority of less than 99. They may be used to simplify logic within the structure of the dialogue.

The basic structure of the dialogue.xml file is as follows:

```
<dialogue>
  <responses>
    <response name=”Response1”>
      <!--Content and rule elements for Response1 here-->
    </response>
    <response name=”Response2”>
      <!--Content and rule elements for Response2 here-->
    </response>
    ...
    <assert name=”Assert1” collate=”true”>
      <event>...</event>
    </assert>
    <assert name=”Assert2” collate=”true”>
      <event>...</event>
    </assert>
    ...
  </responses>
</dialogue>
```

Dialogue Elements
<dialogue> (root)

This element is the root element of the dialogue. All other elements must be contained within the root element. This element is required and an exception will be thrown if it is not present.

There are no attributes for this element.

<responses> (in dialogue)

All <response> and <assert> elements are contained within this element. If this element is not present, the dialogue will have no responses.

There are no attributes for this element.

<response> (in responses)

This element defines the content and rules of a normal response. The elements that define the content and rules are contained within this element and are processed in the order that they are given.

Note that the individual rules are combined to calculate the priority of the response by altering the response's base priority. This determines whether the response will be included in the conflict set or not. Note that in order to suppress the response, a given rule would set the priority to zero.

The attributes are:
name (default: none): the name of the response or “response event” (this name is used to refer to this response, such as within <event> elements);
interruptlevel (default: 0): responses with a higher interrupt level will “interrupt” the speech of responses with a lower interrupt level. If the content of a response is being spoken and a response occurs with a higher interrupt level, the speech will be stopped and an InterruptSpeakingEvent input into the dialogue. Responses with the same name will always interrupt other responses with the same name.
basepriority (default: 1): responses with a higher base priority are always performed before responses with a lower base priority. Responses that have the same base priority may form a “conflict set”. If the priority is 0 or less, the response will never be performed;
baseweight (default: 1): responses with a higher base weight are more likely to be selected from a “conflict set” than responses with a lower base weight. By doubling the weight, the response is twice as likely to occur. If the weight is 0 or less, the response will never be performed;

Note that a given response may have several alternative items of content, which may each be individually weighted, and of which only one may be used when performing the response. This weighting and selection of content is independent of the weighting and selection of the response itself, and allows for a single response to provide multiple alternatives for content without having to define a separate response for each item of content. The selection of an item of content occurs once a given response is to be performed.

Where there is alternative content defined for a response, a single alternative will be selected. The selected item's weight is then adjusted to be less likely to occur the next time the response is selected. As subsequent content is selected for the response, the content becomes more likely to be used again (unless it is used again).

<assert> (in responses)

This element is a special syntax for a response representing an “assertion”, which contains a particular type of rule and no content. It is used for simplifying the structure and logic of the responses.

An assertion occurs (i.e. its conditions are satisfied) when the dialogue contains the events as defined in the assertion.

The attributes are:
name (default: none): the name of the assertion;
repeatafter (default: 1): the number of times that the conditions for the assertion must be satisfied before the assertion is triggered again. If this is 0, the assertion will be triggered once and never again;
minimum (default: 1): the minimum number of times that the conditions for the assertion must be satisfied before the assertion is triggered for the first time;
maximum (default: none): the maximum number of times that the conditions for the assertion can be satisfied to trigger the assertion (a number exceeding this amount will not trigger the assertion again);
collate (default: false): a value in the range [false, true] that defines whether all events must occur in order to trigger the assertion (false) or just one (true)

The events are defined using one or more <event> elements within this element.

Example (if either “Event1” or “Event2” occurs, the
assertion “MyEvent” will occur):

```
  <assert name=“MyEvent” collate=“true”>
    <event>Event1</event>
    <event>Event2</event>
  </assert>
```

<content> (in response)

This element defines content that may be output when the response is performed. The content may be any of the pre-defined types:
text;
textservice;
haptekscript;
unknown

Note that other elements are generally used to provide “text” and “textservice” content. Use this element only for scripts or other custom content.

The attributes are:
type (default: unknown): the content type, which may be any of the pre-defined types;
weight (default: 1): the weight of this content;
file (default: none): the file containing the content

Note that if no file attribute is specified, the content must be defined in a CDATA section within the content element.

### EXAMPLE

```
<content type=”unknown”>
    <![CDATA[
  The content goes here
  ]]>
</content>
```

<text> (in response)

This element defines text content that may be output when the response is performed. Use this element instead of <content> to define text content.

The attributes are:
language (default: en): the language of this content;
weight (default: 1): the weight of this content;
file (default: “text\[response_name]_[language].txt”): the file containing the content;

If the file attribute is not defined and the text element is not empty, then the content will be the content of the element.

### EXAMPLE

<text language=”en” weight=”1”>
The text to be spoken goes here
</text>

If the file attribute is defined, the content of the file is used as the content.

### EXAMPLE

<text file=“c:\filename.txt”/>

If the file attribute is not defined and the text element is empty, then the default filename will be used. The default filename is “text\[response_name] _[language].txt”. Thus, if the response has the name “MyResponse” and the language is “en”, the filename would be “text\MyResponse_en.txt”.

### EXAMPLE

<text />
   <textservice> (in response)

This element defines a service to use to provide text content when the response is performed. The service is the equivalent of a “quote of the day” (QOTD) service running on a particular host. When the response is to be performed, the DialogueManager connects to the service and retrieves the text.

The attributes are:
language (default: en): the language of this content;
weight (default: 1): the weight of this content;
host (default: localhost): the host running the service;
port (default: 17): the port on which to find the service

### EXAMPLE

<textservice host=“myserver” port=“1234”/>
   <emotion> (in response)

This element causes an adjustment to the emotional state in the dialogue.

The attributes are:
type (default: none): the type of emotion to adjust, which are any of the emotional states understood by the character [e.g. happy, sad, anger, fear];
weight (default: 0): the amount by which to adjustment the emotion (either positive or negative);
millis (default: 0): the amount of time (in milliseconds) to take to adjust the emotion

Note that each emotion has a minimum and maximum overall weighting. Thus you cannot adjust an emotion's weight above the maximum or below the minimum.

### EXAMPLE

<emotion type=“happy” weight=“+1” millis=“1000”/>
   <neutraliseemotion> (in response)

This element causes the emotional state to be immediately neutralised.

There are no attributes for this element.

<reset> (in response)

This element causes the dialogue to reset.

There are no attributes for this element.

<detach> (in response)

This element causes the dialogue to be detached.

There are no attributes for this element.

<delayed> (in response)

This element causes the response to be delayed until a certain period of time has elapsed since any one of the checked events occurred.

The attributes are:
millis (default: 0): the amount of time to delay

Example (wait 30 seconds since either “Event1” or “Event2” occurred):

```
<delayed millis=“30000”>
  <event>Event1</event>
  <event>Event2</event>
</delayed>
```

<counted> (in response)

This element allows the response to occur up to a maximum number of times, either overall or consecutively. If the response has not yet occurred the maximum number of times, then it may occur.

The attributes are:
maximum (default: 0): the maximum number of times that the response may occur;
consecutively (default: false): in the range [true, false] to determine whether the counting is done consecutively (true) or overall (false), where “consecutively” is if the previous response was this response;

Example (allow the response to occur up to 3 times):
<counted maximum=“3”/>
   <following> (in response)

This element allows the response to occur if any of the checked events have occurred within a given period of time since the last time this response occurred or the last time a particular delimiter event occurred (whichever occurred most recently).

The attributes are:
millis (default: none): the maximum amount of time before now in which the events may have occurred;
delimiter (default: none): if specified, events that occurred before the last delimiter event are ignored (as if the dialogue started at the delimiter);
noquench (default: false): in the range [true, false] to determine whether we consider this response to be a delimiter to itself (false) or not (true);

Example (allow the response if either “Event1” or “Event2” has occurred since either the last time “MyDelimiterEvent” occurred, or since the response itself occurred [whichever occurred most recently]):

```
<following delimiter=“MyDelimiterEvent”>
  <event>Event1</event>
  <event>Event2</event>
</following>
```

<countevents> (in response)

This element allows the response to occur if either one or all of the checked events have occurred a particular number of times since the last time the response was performed. Note that this element provides similar behaviour to the <assert> element.

The attributes are:
repeatafter (default: 1): the number of times that the checked events must occur before the response may occur again. If this is 0, the response may occur once only;
minimum (default: 1): the minimum number of times that the checked events must occur before the response can be performed for the first time;
maximum (default: none): the maximum number of times that the checked events may occur in order to perform the response (a number exceeding this amount will not allow the response again);
collate (default: false): a value in the range [false, true] that defines whether all events must occur in order to allow the response (false) or just one (true)

Example (allow the response if either “Event1” or “Event2” has occurred since the last time the response was performed, providing the same behaviour as the <assert> element):

```
<countevents collate=”true”>
  <event>Event1</event>
  <event>Event2</event>
</countevents>
```

<checkevents> (in response)

This element allows the response to occur if the checked events have occurred or not occurred at a certain time in relation to when this response last occurred.

The attributes are:
mode (default: any): a value in the range [none, one, any, all] that defines whether none of the events must have occurred, exactly one of the events must have occurred, one or more (any) of the events must have occurred, or all of the events must have occurred;
time (default: ignore): a value in the range [beforelast, afterlast, ignore] that defines whether events are checked before the last time this response occurred, after the last time this response occurred, or regardless (ignore) of when this response last occurred

Example (allow the response if both “Event1” and “Event2” have occurred since the last time this response was performed):

```
<checkevents mode=”all” time=”afterlast”>
  <event>Event1</event>
  <event>Event2</event>
</checkevents>
```

<decaytimeweighted> (in response)

This element adjusts the weight of the response by how long ago the response was last performed.

The attributes are:
mode (default: linear): a value in the range [linear] that defines the decay curve;
fromfactor (default: 0): the factor to apply when the response is used. The weight will decay from this factor back to 1;
millis (default: 0): The amount of time for the decay to occur;

Example (prevent the response again immediately after it is performed [fromfactor is 0], and over the course of 60 seconds return the weight to its original value):
<decaytimeweighted millis=“60000”/>
   <decayeventweighted> (in response)

This element adjusts the weight of the response by how many checked events have occurred since the response was last performed. If no events are checked, the response checks against itself.

The attributes are:
mode (default: linear): a value in the range [linear] that defines the decay curve;
fromfactor (default: 0): the factor to apply when the response is used. The weight will decay from this factor back to 1;

numberofevents (default: 0): The number of events required for complete decay;

Example (prevent the response again immediately after it is performed [fromfactor is 0], and once 5 events of the same name as the response have occurred its weight will be the original value again):
<decayeventweighted numberofevents=“5”/>

Example (make the response twice as likely immediately after it is performed, and once “Event1” has occurred 5 times its weight will be the original value again):

<decayeventweighted fromfactor=”2” numberofevents=”5”>
<event>Event1</event>
</decayeventweighted>

<emotionweighted> (in response)

This element adjusts the weight of the response based on the emotional state. The response may be suppressed if the emotional state does not exhibit the checked emotion and the element requires the emotion to be exhibited.

Note that the weight is adjusted by the following formula:
[base weight]*[emotion proportional weight]*[factor]

If we are checking the “happy” emotion, and the overall emotional state is 100% happy, the “emotion proportional weight” is 1.0. If the overall emotional state is 60% happy and 40% sad, the “emotion proportional weight” is 0.6.

The attributes are:
emotion (default: none): the emotion to check;
required (default: false): a value in the range [true, false] that defines whether the level of the checked emotion must be exhibited (true) or not (false);
dominant (default: false): a value in the range [true, false] that defines whether the checked emotion must be the dominant emotion (true) or not (false);
factor (default: 1): the factor to apply to the response's weight and the emotion's proportional weight;

Example (the response is allowed only if the dominant emotion is “happy” and, if so, the weight adjustment formula is applied using a factor of 10):
<emotionweighted emotion=“happy” dominant=“true” factor=“10”/>
   <class> (in response)

This element instantiates a custom class that is derived from EncapsulatedDialogueResponse to perform the response and calculate the priority and weight.

The attributes are:
name (default: none): the name of the class to instantiate;

Example (the response is allowed only if the dominant emotion is “happy” and, if so, the weight adjustment formula is applied using a factor of 10):
<class name=“MyAssembly.MyClass/>
   <norepeat> (in response)

This element allows a response to occur only once.

Use this element as an alternative to the <counted> element.

There are no attributes for this element.

<interval> (in response)

This element prevents a response from repeating until a period of time has elapsed since it last occurred.

Use this element as an alternative to the <delayed> element.

The attributes are:
millis (default: 0): the amount of time in milliseconds to prevent the response from repeating;
   <requires> (in response)

This element allows a response to occur only if the checked events have all occurred.

Use this element as an alternative to the <checkevents> element.

There are no attributes for this element.

### EXAMPLE

<requires>
<event>Event1</event>
</requires>

<conflicts> (in response)

This element prevents a response from occurring if any of the checked events have occurred.

Use this element as an alternative to the <checkevents> element.

There are no attributes for this element.

### EXAMPLE

<conflicts>
<event>Event1</event>
</conflicts>

Response Text Format
Dynamic Content

You may embed tags for dynamic content within the text. The tags are replaced with a dynamic value just before the text is spoken. Note that you must only use a tag at a point in the dialogue when it will have a value. For example, you must only use the {customer} tag when you are sure that the customer is identified.

Tags are enclosed in {and} characters, such as in the following example:
{name-of-tag}

The following tags are available:
period-of-day: The period of the day in the range [morning, afternoon, evening] (as in “Good morning”);
barmaid-name: The name of the barmaid (e.g. “Monica”);
customer: The best name of the current customer (e.g. “John”, “Mr. Smith”), or “unknown”;
customer-fullname: The full name of the customer, including their title, if known (e.g. Mr. John Smith);
last-customer: The first name of the last customer (e.g. “John”), or “unknown”;
last-product-selected: The name of the last product scanned, prior to size selection (e.g. “Jim Beam”), or “unknown”;
last-product-information: The information for the last product scanned;
last-product-recorded: The name of the last product recorded, following size selection (e.g. “Bottle of Jim Beam”), or “nothing”;
last-product-recorded-with-count: The name and count of the last product recorded, following size selection (e.g. “2 Bottles of Jim Beam”), or “nothing”;
product-summary: A detailed product summary, giving the total value of recorded products and the “last-product-recorded-with-count” for each product recorded, or “nothing”;
product-summary-concise: A concise product summary, giving the total value of recorded products and the number of items recorded, or “nothing”;
popular-product: The name of the most popular product, or “nothing”;
favourite-product: The name of the product the appears to be the customer's favourite (based on previous sales), or “nothing”;
all-products: The names of all the products, separated by periods;
product-catalogue: The names of the products of the type(s) for the last ProductCatalogueEvent
   Text File

The response text file that is read for use with the <text> element contains the text to be used as the content alternatives for a particular response.

Each line of the file is an item of content and has the text to use with an optional weight (the default weight is “1.0”). Leading and trailing whitespace is removed from each line and blank lines and lines beginning with a “#” are then ignored.

Each line is in the following format, where the weight is a decimal in the format “1.0”:
<the text to say>[:[<weight>]]

To include a content that has no text, specify a weight only (orjust the colon to use the default weight of “1.0”):
:[<weight>]

Note that the last colon on the line is considered to delimit the text from the weight. If you need to include colons in your text, be sure to end the line with a colon as well.

If the line ends with more than one period, each period pair is converted to a “\\pau=2000\\”. For example, if the line ends with three periods (e.g. “My text . . . ”), it will be converted to “My text.\\pau=2000\\\\pau=2000\\”. Note that this conversion happens at the same time as the substitutions are processed.

### EXAMPLE

# Example text response file
Mary had a little lamb
This text is twice as likely as the line above:2.0
The next line has no text and a default weight of 1.0
:
A line with no text means a silent response
If your text includes a colon: end the line with one too:
   Substitutions
   Description

Substitutions allow for corrections to the spoken text and are processed immediately prior to the text being sent to the TTS engine. The corrections made occur only in the text that is spoken by the TTS engine.

Substitutions are contained within the “substitutions.xml” file. Note that this file is required for the correct operation of the system.

There are two kinds of substitutions:
Regular expression-based search and replacements;
TTS-pronunciation
   Regular Expression Substitutions

These substitutions use a regular expression to search for text, which is then replaced by the substitute text immediately before being sent to the TTS engine.

There are two variations in the syntax for these substitution elements, examples of which are shown below (the examples replace the word “Le Champs” with “Le-Sharnz”):

Example (Single Expression)

<substitution regex=“\bLe Champs\b” substitute=“Le-Sharnz”/>

Example (Single or Multiple Expressions)

<substitution substitute=“Le-Sharnz”>
<regex>\bLe Champs\b</regex>
</substitution>

Note that the regular expressions are always case insensitive.

TTS Pronunciation Substitutions

These substitutions use a feature of the TTS engine to set the pronunciation of words. They do not alter the text sent to the TTS engine.

The element specifies the pronunciation for a given word. In the examples below, the pronunciation of the word “Carbernet” is set to “carburNay”.

### EXAMPLE

<pronunciation text=“Cabernet” pronunciation=“carburNay”/>

### XML/Dialogue Manual Addendum

Specific Responses

The additional dialogue elements specified below are to be read as additions under section 2 of the Dialogue Manual (version 1.0) for the Virtual Barmaid. They exist to support configuration of application-specific dialogue rules.

setcustomer (in response)

This element causes the most recently selected customer to become the current customer in the dialogue. An object (in memory) representing the customer is then set for the duration of the dialogue.

The attributes are:
mode (default: Normal): a value in the range [ResetDialogue, Normal] to determine whether to clear the dialogue state on setting the customer, or not (respectively)
   customerselected (in response)

This element applies a rule based on the most recently selected customer. Depending on the mode used, the rule will allow the response if the most recently selected customer is:
Nothing (mode=None);
The first to be selected (mode=First);
The first to be selected and is the same is the last customer to have used the system (mode=FirstSameAsLast);
The same as the previous customer to have been selected (mode=Duplicate);
Different to the previous customer to have been selected (mode=Different);
Not nothing (mode=Any)

The attributes are:
mode (default: Any): a value in the range [None, First, FirstSameAsLast, Duplicate, Different, Any]
   customerprevioususe (in response)

This element applies a rule based on the time at which the current customer was last recorded as having used the system. Depending on the mode used, the rule will allow the response if the current customer:
Has never used the system before (Mode=None);
Is the same as the customer that previously used the system (Mode=SameAsLast);
Is not the same as the customer that previously used the system (Mode=NotSameAsLast);
Has very recently used the system (Mode=VeryRecent);
Has semi-recently used the system (Mode=SemiRecent);
Has used the system some time ago (Mode=NotRecent);
Has used the system before (Mode=Any)

The attributes are:
mode (default: Any): a value in the range [None, SameAsLast, NotSameAsLast, VeryRecent, SemiRecent, NotRecent, Any]
   setproductsize (in response)

This element causes the most recently selected product's size to be set to the specified size, if it is unknown.

The attributes are:
size (default: 0): the id of the size
   aAddproduct (in response)

This element causes the most recently selected product to be added to the list of current products that the customer is purchasing. If the most recently selected product's size is unknown, this element will do nothing.

There are no attributes for this element.

removeproduct (in response)

This element causes the last product in the list of current products that the customer is purchasing to be removed.

There are no attributes for this element.

productselected (in response)

This element applies a rule based on the most recently selected product. Depending on the mode used, the rule will allow the response if the most recently selected product is:
Nothing (Mode=None);
The only product to have been selected (Mode=One);
One of several products to have been selected thus far (Mode=Several);
Not nothing (Mode=Any);
A wine (Mode=Wine);
Not a wine (Mode=NotWine);
Of known size (Mode=SizeKnown);
Of unknown size (Mode=SizeUnknown)

The attributes are:
mode (default: Any): a value in the range [None, One, Several, Any, Wine, NotWine, SizeKnown, SizeUnknown]
   productrecorded (in response)

This element applies a rule based on the list of current products that the customer is purchasing. Depending on the mode used, the rule will allow the response if the list contains:
No products (Mode=None);
One product (Mode=One);
More than one product (Mode=MoreThanOne);
Only a few products (Mode=Few);
Many products (Mode=Many);
At least one product (Mode=Any)

The attributes are:
mode (default: Any): a value in the range [None, One, MoreThanOne, Few, Many, Any]
   popularproduct (in response)

This element applies a rule based on whether the system has identified a popular product. Depending on the mode used, the rule will allow the response if the popular product:
Is not known (Mode=None);
Is known (Mode=Any)

The attributes are:
mode (default: Any): a value in the range [None, Any]
   favouriteproduct (in response)

This element applies a rule based on whether the system has identified a favourite product for the current customer. Depending on the mode used, the rule will allow the response if the favourite product:
Is not known (Mode=None);
Is known (Mode=Any)

The attributes are:
mode (default: Any): a value in the range [None, Any]
   chargeproducts (in response)

This element causes the list of products that the customer is purchases to be immediately charged to the customer's account.

There are no attributes for this element.

1. A computer program for use in a self-service engine that generates responses to events relating to customer activity, the program being adapted to:
receive input indicating a detected event in relation to an activity,
generate a candidate set of possible responses by using a set of rules, wherein each rule associates one or more possible events with one or more possible responses,
select one response from the candidate set of possible responses, and
generate the selected response for rendering on one or more output devices.

2. A computer program according to claim 1 wherein to generate a candidate set of possible responses, the set of rules is used to identify those responses that are appropriate for the detected event by generating a priority for each response, wherein the one or more responses with the highest priority are included in the candidate set of possible responses.

3. A computer program according to claim 2 wherein the set of rules further generates a weighting for each identified response, and wherein one response is selected from the candidate set of possible responses using a random process with each possible response being biased according to the weighting.

4. A computer program according to claim 3 wherein the selected response is rendered to dynamically include variable content from external sources.

5. A computer program according to claim 4 further adapted to model an emotional state and modify the priority and/or weighting of each response.

6. A computer program according to claim 1 wherein the computer program is adapted for use in a self-service engine that is implemented in a business management system of one of:
a retail outlet,
a restaurant,
a bar,
an accommodation provider,
video rental store,
a gaming outlet,
a car rental outlet,
a travel outlet, and
an information kiosk.

7. A computer program according to claim 6 wherein the event is one or more of:
a communication by the customer,
an action by the customer, and
a previous response by the self-service engine.

8. A computer program according to claim 7 wherein a response is one or more of:
dialogue,
an assertion,
an instruction,
provision of information,
modification of a menu,
operation of a device, and
operation of a transaction system.

9. A computer program according to claim 8 wherein the generated response is rendered as one or more of:
a human-like animation,
a non-human animation,
a voice,
text output,
a printout,
operation of a device, and
an image.

10. A business management system implementing a self-service engine for facilitating interactions with a customer comprising:
one or more input devices for detecting an event associated with a customer interaction,
a transaction system for effecting a transaction instigated by a customer,
a transaction system interface for transferring information relating to the interaction to or from the transaction system,
a response generator coupled to one or more of the input devices, for generating a response to a detected event, the response generator comprising:
a datastore containing a set of rules, wherein each rule associates one or more possible events with one or more possible responses, and
a processor for determining a candidate set of possible responses to a detected event based on the set of rules, and for selecting one response from the candidate set of possible responses, and
one or more output devices coupled to the response generator for rendering the selected response to the customer.

11. A business management system according to claim 10 wherein to determine the candidate set of possible responses, the processor uses the set of rules to identify those responses that are appropriate for the detected event by generating a priority for each identified response, wherein the one or more responses with the highest priority are included in the candidate set of possible responses.

12. A business management system according to claim 11 wherein the processor further generates a weighting for each identified response, and wherein the processor selects one response from the candidate set of possible responses using a random process with each possible response being biased according to its respective weighting.

13. A business management system according to claim 12 wherein the selected response is rendered to dynamically include variable content from external sources.

14. A business management system according to claim 13 wherein the processor is further adapted to model an emotional state and modify the priority and/or weighting of each response.

15. A business management system according to claim 10 wherein the event includes one or more of:
a communication by the customer,
an action by the customer, and
a previous response by the response generator.

16. A business management system according to claim 15 wherein the business management system is implemented in one of:
a retail outlet,
a restaurant,
a bar,
an accommodation provider,
video rental store,
a gaming outlet,
a car rental outlet,
a travel outlet, and
an information kiosk.

17. A business management system according to claim 16 wherein the transaction system is one or more of:
a reservation system,
a point of sale system,
a customer loyalty database,
a marketing database,
an internet host database
an inventory control system, and
an information database for a information kiosk.

18. A business management system according to claim 17 wherein a response is one or more of:
dialogue,
an assertion,
an instruction,
provision of information,
modification of a menu,
operation of a device, and
operation of a transaction system.

19. A business management system according to claim 18 wherein the selected response is rendered as one or more of:
a human-like animation,
a non-human animation,
a voice
text output,
a printout,
operation of a device, and
an image.

20. A business management system according to claim 19 wherein the one or more output devices are one or more of:
a visual display, and
an audio speaker.

21. A business management system according to claim 20 wherein the one or more input devices are one or more of:
a touch screen,
a microphone,
a motion sensor,
a camera,
a payment card reader,
a barcode scanner,
printer, and
text service provider.

22. A self-service engine for facilitating interactions between a customer and a transaction system of an enterprise comprising:
one or more input devices for detecting an event associated with a customer interaction,
a transaction system interface for transferring information relating to the interaction to and from a transaction system of an enterprise,
a response generator coupled to one or more of the input devices, for generating a response to a detected event, the response generator comprising:
a datastore containing a set of rules, wherein each rule associates one or more possible events with one or more possible responses, and
a processor for determining a candidate set of possible responses to a detected event based on the set of rules, and for selecting one response from the candidate set of responses, and
one or more output devices coupled to the response generator for conveying the selected response to the customer.

23. A self-service engine according to claim 22 wherein to determine the candidate set of possible responses, the processor uses the set of rules to identify those responses that are appropriate for the detected event by generating a priority for each identified response, wherein the one or more responses with the highest priority are included in the candidate set of possible responses.

24. A self-service engine according to claim 23 wherein the processor further generates a weighting for each identified response, and wherein the processor selects one response from the candidate set of possible responses using a random process with each possible response being biased according to its respective weighting.

25. A self-service engine according to claim 24 wherein the selected response is rendered to dynamically include variable content from external sources.

26. A self-service engine according to claim 25 wherein the processor is further adapted to model an emotional state and modify the priority and/or weighting of each response.

27. A self-service engine according to claim 22 wherein the event includes one or more of:
a communication by the customer,
an action by the customer, and
a previous response by the business management system.

28. A self-service engine according to claim 27 wherein the business management system is implemented in one of:
a retail outlet,
a restaurant,
a bar,
an accommodation provider,
video rental store,
a gaming outlet,
a car rental outlet,
a travel outlet, and
an information kiosk.

29. A self-service engine according to claim 28 wherein the transaction system is one or more of:
a reservation system,
a point of sale system,
a customer loyalty database,
a marketing database,
an internet host database
an inventory control system, and
an information database for a information kiosk.

30. A self-service engine according to claim 29 wherein a response is one or more of:
dialogue,
an assertion,
an instruction,
provision of information,
modification of a menu,
operation of a device, and
operation of a transaction system.

31. A self-service engine according to claim 30 wherein the selected response is rendered as one or more of:
a human-like animation,
a non-human animation
a voice
text output,
a printout,
operation of a device, and
an image.

32. A self-service engine according to claim 31 wherein the one or more output devices are one or more of:
a visual display, and
an audio speaker.

33. A self-service engine according to claim 32 wherein the one or more input devices are one or more of:
a touch screen,
a microphone,
a motion sensor,
a camera,
a payment card reader,
a barcode scanner,
printer, and
text service provider.

34. A response generator, for use in a self-service engine, that generates responses to events relating to customer activity, comprising:
an input interface for coupling to one or more input devices adapted to detect an event associated with a customer transaction,
a datastore containing a set of rules that associate one or more events with one or more responses,
a processor that can access the datastore and input interface for determining a candidate set of possible responses to a detected event based on the set of rules, and for selecting one response from the candidate set of responses, and
an output interface for providing the selected response to one or more output devices adapted to render the selected response for the customer.
